(19) United States
(12) Patent Application Publication
(10) Pub. No.: US 2015/0092752 A1
(43) Pub. Date: Apr. 2, 2015

(54) GRANT PROCESSING FOR FLEXIBLE BANDWIDTH CARRIER SYSTEMS

(71) Applicant: QUALCOMM Incorporated, San Diego, CA (US)

(72) Inventors: Ozgur Dural, San Diego, CA (US); Soumya Das, San Diego, CA (US); Edwin Chongwoo Park, San Diego, CA (US)

(73) Assignee: QUALCOMM Incorporated, San Diego, CA (US)

(21) Appl. No.: 14/038,868

(22) Filed: Sep. 27, 2013

(51) Int. Cl. H04W 74/00; H04W 72/04

(52) U.S. Cl. CPC H04W 74/002; H04W 72/0446
USPC 370/336

(57) ABSTRACT

Methods, systems, and devices are described for control information processing and utilization in a wireless communications system that utilizes one or more flexible bandwidth carriers. The methods may include receiving control information over a first channel of one of the one or more flexible bandwidth carriers, determining a processing time for the received control information over the first channel of the one of the one or more flexible bandwidth carriers based on a processing time of control information for another bandwidth carrier, and utilizing the received control information over the first channel of the one of the one or more flexible bandwidth carriers during a first transmission time interval of the first channel of the one of the one or more flexible bandwidth carriers subsequent to the processing time for the received control information over the first channel of the one of the one or more flexible bandwidth carriers.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, 3GPP Long Term Evolution (LTE) systems, and orthogonal frequency-division multiple access (OFDMA) systems.

Service providers are typically allocated blocks of frequency spectrum for exclusive use in certain geographic regions. These blocks of frequencies are generally assigned by regulators regardless of the multiple access technology being used. In most cases, these blocks are not integer multiples of channel bandwidths, hence there may be unutilized parts of the spectrum. As the use of wireless devices has increased, the demand for and value of this spectrum has generally surged, as well. Nonetheless, in some cases, wireless communications systems may not utilize portions of the allocated spectrum because the portions are not big enough to fit a standard or normal waveform. The developers of the LTE standard, for example, recognized the problem and decided to support many different system bandwidths (e.g., 1.4, 3, 5, 10, 15 and 20 MHz). This may provide one partial solution to the problem.

Flexible bandwidth systems, also referred to herein as scalable bandwidth systems, may provide for better utilization of bandwidth resources. However, some flexible bandwidth systems may face timing issues due to time dilation when they include multiple carriers that may utilize different bandwidths.

### SUMMARY

Methods, systems, and devices are provided for control information processing and utilization, such as for optimizing timing relations, in a wireless communications system that utilizes one or more flexible bandwidth carriers. For example, tools and techniques are provided that may help optimize, such as by aligning, the processing time of control information for a flexible or scalable bandwidth carrier to conform to the processing time for a system that may utilize a normal bandwidth carrier or another flexible bandwidth carrier.

Optimizing and/or aligning the processing time in a flexible bandwidth carrier system may include receiving control information over a first channel of one or more flexible bandwidth carriers, determining a processing time for the received control information over the first channel of the one or more flexible bandwidth carriers based on a processing time of control information for a normal bandwidth carrier or another flexible bandwidth carrier, and utilizing the received control information over the first channel of the one or more flexible bandwidth carriers during a first transmission time interval (TTI) of the first channel of the one or more flexible bandwidth carriers subsequent to the processing time for the received control information over the first channel of the one or more flexible bandwidth carriers. These tools and techniques may also be utilized with multicarrier systems that may utilize one or more flexible bandwidth carriers and one or more normal bandwidth carriers, and/or systems that may utilize multiple different flexible bandwidth carriers having different bandwidth scaling factors.

Flexible bandwidth carriers for wireless communications systems may utilize portions of spectrum that may not be big enough to fit a normal waveform utilizing flexible bandwidth waveforms. A flexible bandwidth system that utilizes a flexible bandwidth carrier may be generated with respect to a normal bandwidth system through dilating, or scaling down, the time or the chip rate of the flexible bandwidth system with respect to the normal bandwidth system. Some embodiments may increase the bandwidth of a waveform through expanding, or scaling up, the time or the chip rate of the flexible bandwidth system.

In wireless communications systems that may utilize one or more flexible bandwidth carriers, dilated control information processing times and utilization for a flexible bandwidth carrier may cause an increase in required system resources, such as increased grant processing time and consequently grant delays and a decrease in overall system efficiency relative to a system that utilizes normal bandwidth carriers or other flexible bandwidth carriers. In general, certain time periods may be defined for the application of different grants. Simply dilating these time periods for a flexible or scalable bandwidth carrier relative to a normal bandwidth carrier or another flexible bandwidth carrier may result in an increased time between when a grant is provided to a user equipment and when the user equipment actually utilizes it. For example, with dilation, a grant may be applied in a frame later than if the processing time was not dilated. In other words, dilatation may cause unwanted delay in the application of a grant. These problems may be addressed by aligning the processing time for control information for at least two carriers in a multicarrier system, for example, by configuring a control information processing time on one channel, such as a flexible or scalable bandwidth carrier, to align with a control information processing time for a normal bandwidth carrier or another flexible bandwidth carrier.

Methods for control information processing time and utilization alignment may be particularly useful in a multicarrier High-Speed Uplink Packet Access (HSUPA) network that may utilize a primary serving Uplink High Speed-Dedicated Physical Control Channel (HS-DPCCH cell) with a normal chip rate, such as 3.84 Mcps (e.g., N=1) and a secondary serving HS-DPCCH cell(s) that may utilize a time dilated chip rate=3.84/2 Mcps (e.g., N=2) or 3.84/4 Mcps (e.g., N=4) or vice versa. Tools and techniques provided may support alignment of control information processing time and utilization between carriers having different chip rates, such as between the primary serving HS-DPCCH cell (which may have N=1) and secondary serving HS-DPCCH cell(s) (which may utilize a flexible bandwidth carrier, such as with N=2 or N=4), vice versa, and/or between a primary serving HS-DPCCH cell (which may have N=2) and a secondary serving HS-DPCCH cell (which may have N=4).

Some embodiments include a method of control information processing and utilization for a wireless communications system that utilizes one or more flexible bandwidth carriers. The method may include: receiving control information over a first channel of one of the one or more flexible bandwidth carriers; determining a processing time for the received control information over the first channel of the one of the one or more flexible bandwidth carriers based on a processing time of control information for a normal bandwidth carrier or another flexible bandwidth carrier; and/or utilizing the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

In some embodiments, the method may further include: receiving the control information for the normal bandwidth carrier or the other flexible bandwidth carrier over a channel of the normal bandwidth carrier or the other flexible bandwidth carrier; and/or utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In yet other embodiments, the method may include: receiving control information over a second channel of one of the one or more flexible bandwidth carriers; determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and/or utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

In some embodiments, determining the processing time for the received control information over the first channel of the one of the one or more flexible bandwidth carriers may include determining at least a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In other cases, the processing time for the received control information over the first channel of the one of the one or more flexible bandwidth carriers may be less than a dilated processing time for the received control information over the first channel of the one of the one or more flexible bandwidth carriers.

In some embodiments, the control information over the first channel of one of the one or more flexible bandwidth carriers may include one or more grants. In some embodiments, the first channel of the one of the one or more flexible bandwidth carriers may include at least an Enhanced Absolute Grant Channel (E-AGCH) or an Enhanced Relative Grant Channel (E-RGCH). In some cases, the one of the one or more flexible bandwidth carriers of the first channel may include a bandwidth scaling factor equal to 2 or 4.

Some embodiments may include a system for control information processing and utilization in a wireless communications system that utilizes one or more flexible bandwidth carriers. The system may include: means for receiving control information over a first channel of one of the one or more flexible bandwidth carriers; means for determining a processing time for the received control information over the first channel of the one of the one or more flexible bandwidth carriers based on a processing time of control information for a normal bandwidth carrier or another flexible bandwidth carrier; and/or means for utilizing the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.\

The system, in some cases, may also include: means for receiving the control information for the normal bandwidth carrier or the other flexible bandwidth carrier over a channel of the normal bandwidth carrier or the other flexible bandwidth carrier; and/or means for utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In some embodiments, the system may further include: means for receiving control information over a second channel of one of the one or more flexible bandwidth carriers; means for determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and/or means for utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

The means for determining the processing time for the received control information over the first channel of the one of the one or more flexible bandwidth carriers may include means for determining at least a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In other cases, the processing time for the received control information over the first channel of the one of the one or more flexible bandwidth carriers may be less than a dilated processing time for the received control information over the first channel of the one of the one or more flexible bandwidth carriers.

In some embodiments, the control information over the first channel of one of the one or more flexible bandwidth carriers may include one or more grants. In some embodiments, the first channel of the one of the one or more flexible bandwidth carriers may include at least an Enhanced Absolute Grant Channel (E-AGCH) or an Enhanced Relative Grant Channel (E-RGCH). In some cases, one of the one or more flexible bandwidth carriers of the first channel may include a bandwidth scaling factor equal to 2 or 4.

Some embodiments may include a computer program product for control information processing and utilization in a wireless communications system that utilizes one or more flexible bandwidth carriers that may include a non-transitory computer-readable medium. The non-transitory computer readable medium may include: code for receiving control information over a first channel of one of the one or more flexible bandwidth carriers; code for determining a processing time for the received control information over the first channel of the one of the one or more flexible bandwidth carriers based on a processing time of control information for a normal bandwidth carrier or another flexible bandwidth carrier; and/or code for utilizing the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

In some embodiments, the non-transitory computer-readable medium may further include: code for receiving the control information for the normal bandwidth carrier or the other flexible bandwidth carrier over a channel of the normal bandwidth carrier or the other flexible bandwidth carrier; and/or code for utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In other embodiments, the non-transitory computer-readable medium may further include: code for receiving control information over a second channel of one of the one or more flexible bandwidth carriers; code for determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and/or code for utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

The code for determining the processing time for the received control information over the first channel of the one of the one or more flexible bandwidth carriers may include code for determining at least a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In other cases, the processing time for the received control information over the first channel of the one of the one or more flexible bandwidth carriers may be less than a dilated processing time for the received control information over the first channel of the one of the one or more flexible bandwidth carriers.

In some embodiments of the computer program product, the control information over the first channel of one of the one or more flexible bandwidth carriers may include one or more grants. In some embodiments of the computer program product, the first channel of the one of the one or more flexible bandwidth carriers may include at least an Enhanced Absolute Grant Channel (E-AGCH) or an Enhanced Relative Grant Channel (E-RGCH). In some embodiments of the computer program product, the one of the one or more flexible bandwidth carriers of the first channel may include a bandwidth scaling factor equal to 2 or 4.

Some embodiments may include a wireless communications device configured for control information processing and utilization in a wireless communications system that utilizes one or more flexible bandwidth carriers. The wireless communications device may include at least one processor configured to: receive control information over a first channel of one of the one or more flexible bandwidth carriers; determine a processing time for the received control information over the first channel of the one of the one or more flexible bandwidth carriers based on a processing time of control information for a normal bandwidth carrier or another flexible bandwidth carrier; and/or utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

In some embodiments, the at least one processor may be further configured to: receive the control information for the normal bandwidth carrier or the other flexible bandwidth carrier over a channel of the normal bandwidth carrier or the other flexible bandwidth carrier; and/or utilize the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In some embodiments, the at least one processor may be configured to: receive control information over a second channel of one of the one or more flexible bandwidth carriers; determine a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and/or utilize the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

The at least one processor configured to determine the processing time for the received control information over the first channel of the one of the one or more flexible bandwidth carriers may be further configured to determine at least a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In other cases, the processing time for the received control information over the first channel of the one of the one or more flexible bandwidth carriers may be less than a dilated processing time for the received control information over the first channel of the one of the one or more flexible bandwidth carriers.

In some embodiments, the control information over the first channel of one of the one or more flexible bandwidth carriers may include one or more grants. In some embodiments, the first channel of the one of the one or more flexible bandwidth carriers may include at least an Enhanced Absolute Grant Channel (E-AGCH) or an Enhanced Relative Grant Channel (E-RGCH). In some cases, one of the one or more flexible bandwidth carriers of the first channel may include a bandwidth scaling factor equal to 2 or 4.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the spirit and scope of the appended claims. Features which are believed to be characteristic of the concepts disclosed herein, both as to their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the different embodiments may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2A shows an example of a wireless communications system where a flexible bandwidth waveform fits into a portion of spectrum not broad enough to fit a normal waveform in accordance with various embodiments;

FIG. 2B shows an example of a wireless communications system where a flexible bandwidth waveform fits into a portion of spectrum near an edge of a band in accordance with various embodiments;

FIG. 3 shows a block diagram of a wireless communications system in accordance with various embodiments;

FIG. 4A shows a control information timing diagram of two carriers having different bandwidth scaling factors in accordance with various embodiments;

FIG. 4B shows another control information timing diagram of two carriers having different bandwidth scaling factors in accordance with various embodiments;

FIG. 4C shows another control information timing diagram of two carriers having different bandwidth scaling factors in accordance with various embodiments;

FIG. 5A shows a block diagram of a device configured for control information processing and utilization in a multicarrier system that utilizes one or more flexible bandwidth carriers in accordance with various embodiments;

FIG. 5B shows a block diagram of another device configured for control information processing and utilization in a multicarrier system that utilizes one or more flexible bandwidth carriers in accordance with various embodiments;

FIG. 6 shows a block diagram of a communications system configured in accordance with various embodiments;

FIG. 7 shows a block diagram of a user equipment configured in accordance with various embodiments;

FIG. 8 shows a block diagram of a wireless communications system that includes a base station and a user equipment in accordance with various embodiments;

FIG. 9A shows a flow diagram of a method of control information processing and utilization in a multicarrier system that utilizes one or more flexible bandwidth carriers in accordance with various embodiments; and

FIG. 9B shows a flow diagram of another method of control information processing and utilization in a multicarrier system that utilizes one or more flexible bandwidth carriers in accordance with various embodiments.

### DETAILED DESCRIPTION

Methods, systems, and devices are provided for control information processing and utilization, such as for optimizing timing relations, in a wireless communications system that utilizes one or more flexible bandwidth carriers. For example, tools and techniques are provided that may help align the processing time of control information for a flexible or scalable bandwidth carrier to conform to the processing time for a system that may utilize a normal bandwidth carrier or another flexible bandwidth carrier.

Aligning the processing time in a flexible bandwidth carrier system may include receiving control information over a first channel of one of the one or more flexible bandwidth carriers, determining a processing time for the received control information over the first channel of the one of the one or more flexible bandwidth carriers based on a processing time of control information for a normal bandwidth carrier or another flexible bandwidth carrier, and utilizing the received control information over the first channel of the one of the one or more flexible bandwidth carriers during a first transmission time interval (TTI) of the first channel of the one or more flexible bandwidth carriers subsequent to the processing time for the received control information over the first channel of the one of the one or more flexible bandwidth carriers. These tools and techniques may also be utilized with multicarrier systems that may utilize one or more flexible bandwidth carriers and one or more normal bandwidth carriers, and/or systems that may utilize multiple different flexible bandwidth carriers having different bandwidth scaling factors.

Flexible bandwidth carriers for wireless communications systems may utilize portions of spectrum that may not be big enough to fit a normal waveform utilizing flexible bandwidth waveforms. A flexible bandwidth system that utilizes a flexible bandwidth carrier may be generated with respect to a normal bandwidth system through dilating, or scaling down, the time or the chip rate of the flexible bandwidth system with respect to the normal bandwidth system. Some embodiments may increase the bandwidth of a waveform through expanding, or scaling up, the time or the chip rate of the flexible bandwidth system.

In wireless communications systems that may utilize one or more flexible bandwidth carriers, dilated control information processing times and utilization for a flexible bandwidth carrier may cause an increase in required system resources, such as increased grant processing time and consequently grant delays and a decrease in overall system efficiency. In general, certain time periods may be defined for the application of different grants. Simply dilating these time periods for a flexible or scalable bandwidth carrier relative to a normal bandwidth carrier or another flexible bandwidth carrier may result in an increased time between when a grant is provided to a user equipment and when the user equipment actually utilizes it. For example, with dilation, a grant may be applied in a frame later than if the processing time was not dilated. In other words, dilation may cause unwanted delay in the application of a grant. These problems may be addressed by aligning the processing time for control information for at least two carriers in a multicarrier system, for example, by configuring a control information processing time on one channel, such as a flexible or scalable bandwidth carrier, to align with a control information processing for a normal bandwidth carrier or another flexible bandwidth carrier.

Methods for control information processing time and utilization alignment may be particularly useful in a multicarrier High-Speed Uplink Packet Access (HSUPA) network that may utilize a primary serving Uplink High Speed-Dedicated Physical Control Channel (HS-DPCCH cell) with a normal chip rate, such as 3.84 Mcps (e.g., N=1) and a secondary serving HS-DPCCH cell(s) that may utilize a time dilated chip rate=3.84/2 Mcps (e.g., N=2) or 3.84/4 Mcps (e.g., N=4) or vice versa. Tools and techniques provided may support alignment of control information processing time and utilization between carriers having different chip rates, such as between the primary serving HS-DPCCH cell (which may be N=1) and secondary serving HS-DPCCH cell(s) (which may utilize a flexible bandwidth carrier, such as with N=2 or N=4), vice versa, and/or between a primary serving HS-DPCCH cell (which may have N=2) and a secondary serving HS-DPCCH cell (which may have N=4).

In some embodiments, methods for control information processing and utilization may also include receiving the control information for the normal bandwidth carrier or the other flexible bandwidth carrier over a channel of the normal bandwidth carrier or the other flexible bandwidth carrier, and utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In other embodiments, the methods for control information processing and utilization may include receiving control information over a second channel of one of the one or more flexible bandwidth carriers. These methods may further include determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers. In some cases, these methods may include utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

In some embodiments, determining the processing time for the received control information over the first channel of the one of the one or more flexible bandwidth carriers may include determining at least a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In some embodiments, the processing time for the received control information over the first channel of the one of the one or more flexible bandwidth carriers may be less than a dilated processing time for the received control information over the first channel of the one of the one or more flexible bandwidth carriers.

In some cases, the processing time for the received control information over the first channel of the one of the one or more flexible bandwidth carriers may be undilated with respect to the processing time for a normal bandwidth carrier or the other flexible bandwidth carrier. In other words, this may equate to the processing time for the received control information over the first channel of the one of the one or more flexible bandwidth carriers, when adjusted, being un-dilated in relation to other signaling of the flexible bandwidth carrier. In some cases, the processing time across one or more flexible bandwidth carriers and the processing time across a normal bandwidth carrier or the other flexible bandwidth carrier may be constant or near constant. In other cases, all or a portion of the processing time for the one or more flexible bandwidth carriers may align, i.e. be adjusted so as to be undilated/the same length, with respect to the normal bandwidth carrier or the other flexible bandwidth carrier.

In some embodiments, the control information over the first channel of one of the one or more flexible bandwidth carriers may include one or more grants. In some cases, the first channel of the one of the one or more flexible bandwidth carriers may include one of an Enhanced Absolute Grant Channel (E-AGCH) or Enhanced Relative Grant Channel (E-RGCH). The one of the one or more flexible bandwidth carriers may utilize a bandwidth scaling factor equal to 2 or 4.

Techniques described herein may be used for various wireless communications systems such as CDMA, TDMA, FDMA, OFDMA, SC-FDMA, Peer-to-Peer, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA or OFDM system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). Some systems may utilize high speed packet access (HSPA). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above, as well as other systems and radio technologies.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

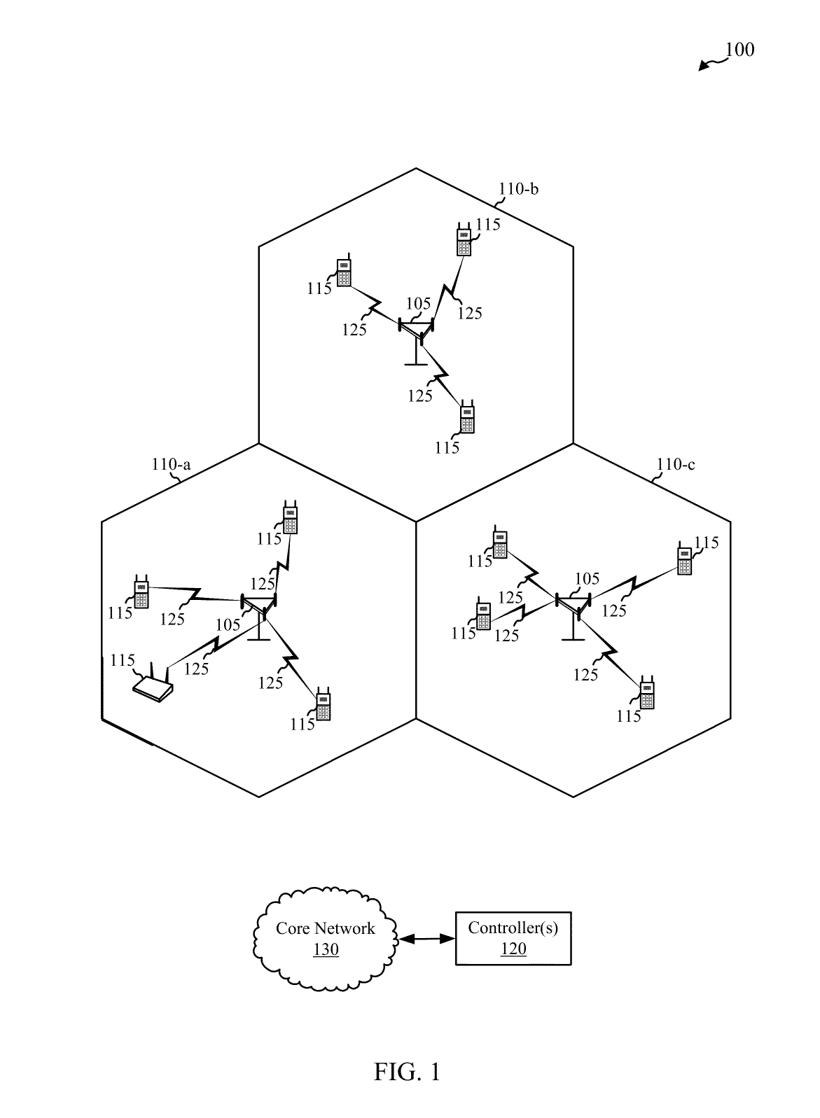

Referring first to FIG. 1, a block diagram illustrates an example of a wireless communications system 100 in accordance with various embodiments. The system 100 includes base stations 105, user equipment (also referred to herein as a UE) 115, a base station controller 120, and a core network 130 (the controller 120 may be integrated into the core network 130 in some embodiments; in some embodiments, controller 120 may be integrated into base stations 105). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, Time Division Multiple Access (TDMA) signal, Frequency Division Multiple Access (FDMA) signal, Orthogonal FDMA (OFDMA) signal, Single-Carrier FDMA (SC-FDMA) signal, etc. Each modulated signal may be sent on a different carrier and may carry control information (e.g., pilot signals), overhead information, data, etc. The system 100 may be a multi-carrier LTE network capable of efficiently allocating network resources.

The user equipment 115 may be any type of mobile station, user equipment, access terminal, subscriber unit, or user equipment. The user equipment 115 may include cellular phones and wireless communications devices, but may also include personal digital assistants (PDAs), smartphones, other handheld devices, netbooks, notebook computers, etc. Thus, the term user equipment should be interpreted broadly hereinafter, including the claims, to include any type of wireless or mobile communications device.

Throughout this application, some user equipment may be referred to as flexible bandwidth capable user equipment, flexible bandwidth compatible user equipment, and/or flexible bandwidth user equipment. This may generally mean that the user equipment is flexible capable or compatible. In general, these devices may also be capable of normal functionality with respect to one or more normal radio access technologies (RATs). The use of the term flexible as meaning flexible capable or flexible compatible may generally be applicable to other aspects of system 100, such as for controller 120 and/or base stations 105, or a radio access network.

The base stations 105 may wirelessly communicate with the user equipment 115 via a base station antenna. The base stations 105 may be configured to communicate with the user equipment 115 under the control of the controller 120 via multiple carriers. Each of the base station 105 sites can provide communication coverage for a respective geographic area. In some embodiments, base stations 105 may be referred to as a NodeB, eNodeB, Home NodeB, and/or Home eNodeB. The coverage area for each base station 105 here is identified as 110-a, 110-b, or 110-c. The coverage area for a base station may be divided into sectors (not shown, but making up only a portion of the coverage area). The system 100 may include base stations 105 of different types (e.g., macro, micro, femto, and/or pico base stations).

The different aspects of system 100, such as the user equipment 115, the base stations 105, the core network 130, and/or the controller 120 may be configured to utilize flexible bandwidth and waveforms in accordance with various embodiments. System 100, for example, shows transmissions 125 between user equipment 115 and base stations 105. The transmissions 125 may include uplink and/or reverse link transmission, from a user equipment 115 to a base station 105, and/or downlink and/or forward link transmissions, from a base station 105 to a user equipment 115. The transmissions 125 may include flexible/scalable and/or normal waveforms. Normal waveforms may also be referred to as legacy and/or normal waveforms.

The different aspects of system 100, such as the user equipment 115, the base stations 105, the core network 130, and/or the controller 120 may be configured to utilize flexible bandwidth or scalable waveforms and/or normal waveforms in accordance with various embodiments. For example, different aspects of system 100 may utilize portions of spectrum that may not be big enough to fit a normal waveform. Devices such as the user equipment 115, the base stations 105, the core network 130, and/or the controller 120 may be configured to adapt the chip rates, spreading factor, and/or scaling factors to generate and/or utilize flexible bandwidth and/or waveforms. Some aspects of system 100 may form a flexible subsystem (such as certain user equipment 115 and/or base stations 105) that may be generated with respect to a normal subsystem (that may be implemented using other user equipment 115 and/or base stations 105) through dilating, or scaling down, the time of the flexible subsystem with respect to the time of the normal subsystem.

In some embodiments, different aspects of system 100, such as the user equipment 115, may be configured to receive control information over a first channel of one of the one or more flexible bandwidth carriers. In some cases, the user equipment 115 may be configured to determine a processing time for the received control information over the first channel of the one of the one or more flexible bandwidth carriers based on a processing time of control information for a normal bandwidth carrier or another flexible bandwidth carrier. The user equipment 115 may be further configured to utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers. At least the first carrier or the second carrier may include at least one of the one or more flexible bandwidth carriers.

In alternative embodiments, different aspects of system 100, such as the base stations 105, the core network 130, and/or the controller 120 may be configured to perform some or all of the above functionality with or in place of the user equipment 115.

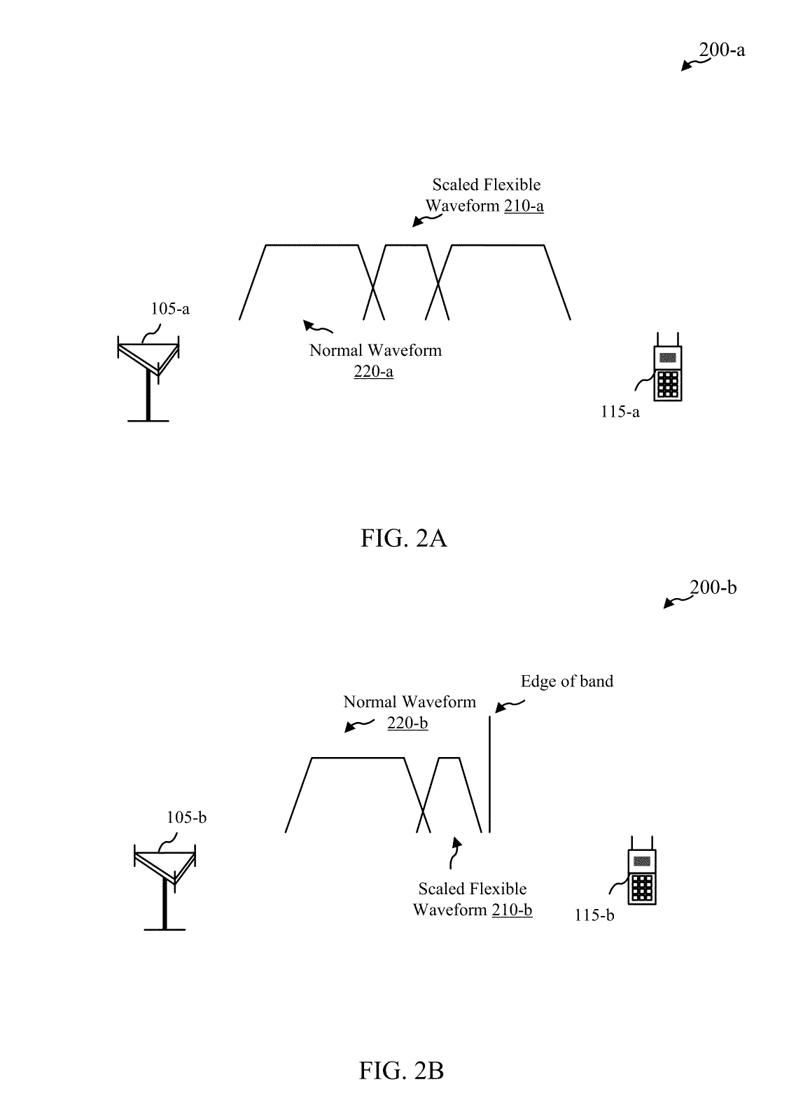

FIG. 2A shows an example of a wireless communications system 200-a with a base station 105-a and a user equipment 115-a in accordance with various embodiments, where a flexible bandwidth waveform 210-a fits into a portion of spectrum not broad enough to fit a normal waveform 220-a. System 200-a may be an example of system 100 of FIG. 1. In some embodiments, the flexible bandwidth waveform 210-a may overlap with the normal waveform 220-a that either the base 105-a and/or the user equipment 115-a may transmit. In some cases, the normal waveform 220-a may completely overlap the flexible bandwidth waveform 210-a. Some embodiments may also utilize multiple flexible bandwidth waveforms 210. In some embodiments, another base station and/or user equipment (not shown) may transmit the normal waveform 220-a and/or the flexible bandwidth waveform 210-a.

FIG. 2B shows an example of a wireless communications system 200-b with a base station 105-b and user equipment 115-b, where a flexible bandwidth waveform 210-b fits into a portion of spectrum near an edge of a band, which may be a guard band, where normal waveform 220-b may not fit. System 200-b may be an example of system 100 of FIG. 1. User equipment 115-a/115-b and/or base stations 105-a/105-b may be configured to dynamically adjust the bandwidth of the flexible bandwidth waveforms 210-a/210-b in accordance with various embodiments.

In some embodiments, different aspects of systems 200-a and/or 200-b, such as the user equipment 115-a and/or 115-b, may be configured to receive control information over a first channel of one of the one or more flexible bandwidth carriers. Different aspects of systems 200-a and/or 200-b, such as the user equipment 115-a and/or 1150-b and/or the base stations 105-a and/or 105-b may be configured to determine a processing time for the received control information over the first channel of the one of the one or more flexible bandwidth carriers based on a processing time of control information for a normal bandwidth carrier or another flexible bandwidth carrier. Different aspects of systems 200-a and/or 200-b, such as the user equipment 115-a and/or 1150-b and/or the base stations 105-a and/or 105-b may be further configured to utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers. At least the first carrier or the second carrier may include at least one of the one or more flexible bandwidth carriers.

In alternative embodiments, different aspects of systems 200-a and/or 200-b, such as the base stations 105-a and/or 105-b may be configured to perform some or all of the functionality described above either with or in place of the user equipment 115-a, 115-b.

In general, a first waveform or carrier bandwidth and a second waveform or carrier bandwidth may partially overlap when they overlap by at least 1%, 2%, and/or 5%. In some embodiments, partial overlap may occur when the overlap is at least 10%. In some embodiments, the partial overlap may be less than 99%, 98%, and/or 95%. In some embodiments, the overlap may be less than 90%. In some cases, a flexible bandwidth waveform or carrier bandwidth may be contained completely within another waveform or carrier bandwidth. This overlap may still reflect partial overlap, as the two waveforms or carrier bandwidths do not completely coincide. In general, partial overlap can mean that the two or more waveforms or carrier bandwidths do not completely coincide (i.e., the carrier bandwidths are not the same).

Some embodiments may utilize different definitions of overlap based on power spectrum density (PSD). For example, one definition of overlap based on PSD is shown in the following overlap equation for a first carrier:

$$overlap = 100 \% * \frac{{\int }_{0}^{∞} {PSD}_{1} ( f ) * {PSD }_{2} ( f )}{{\int }_{0}^{∞} {PSD}_{1} ( f ) * {PSD }_{1} ( f )} .$$

In this equation, PSD₁(f) is the PSD for a first waveform or carrier bandwidth and PSD₂(f) is the PSD for a second waveform or carrier bandwidth. When the two waveforms or carrier bandwidths coincide, then the overlap equation may equal 100%. When the first waveform or carrier bandwidth and the second waveform or carrier bandwidth at least partially overlap, then the overlap equation may not equal 100%. For example, the Overlap Equation may result in a partial overlap of greater than or equal to 1%, 2%, 5%, and/or 10% in some embodiments. The overlap equation may result in a partial overlap of less than or equal to 99%, 98%, 95%, and/or 90% in some embodiments. One may note that in the case in which the first waveform or carrier bandwidth is a normal waveform or carrier bandwidth and the second waveform or a carrier waveform is a flexible bandwidth waveform or carrier bandwidth that is contained within the normal bandwidth or carrier bandwidth, then the overlap equation may represent the ratio of the flexible bandwidth compared to the normal bandwidth, written as a percentage. Furthermore, the overlap equation may depend on which carrier bandwidth's perspective the overlap equation is formulated with respect to. Some embodiments may utilize other definitions of overlap. In some cases, another overlap may be defined utilizing a square root operation such as the following:

$$overlap = 100 \% * \sqrt{\frac{{\int }_{0}^{∞} {PSD}_{1} ( f ) * {PSD }_{2} ( f )}{{\int }_{0}^{∞} {PSD}_{1} ( f ) * {PSD }_{1} ( f )}} .$$

Other embodiments may utilize other overlap equations that may account for multiple overlapping carriers.

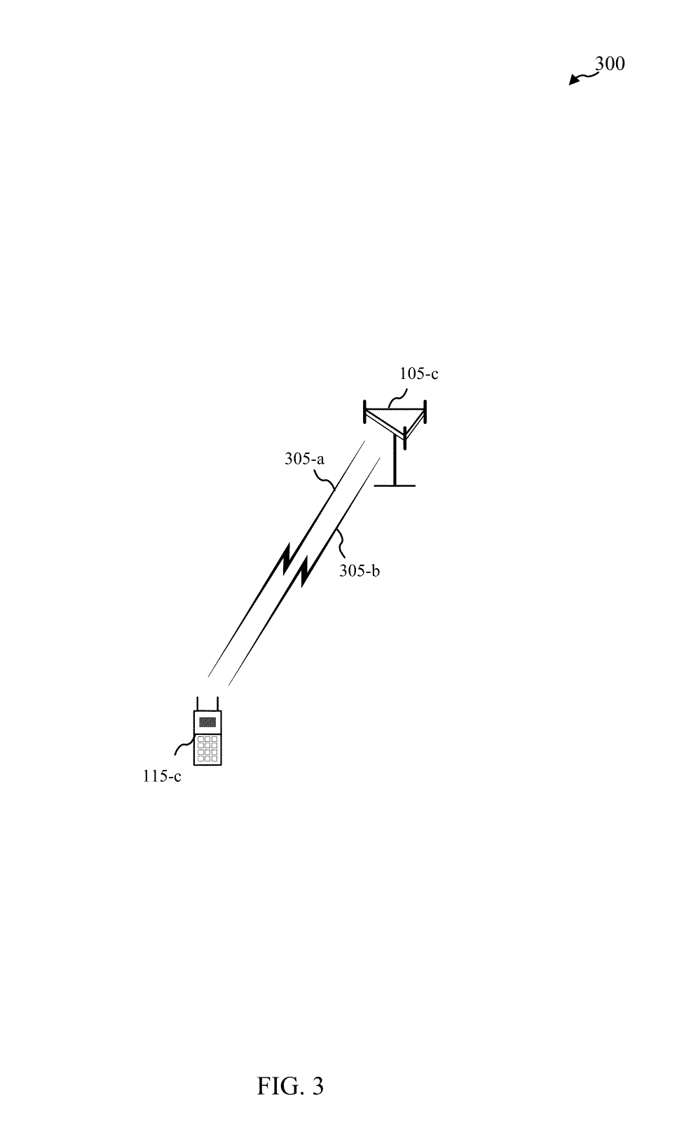

FIG. 3 shows a wireless communications system 300 with a base station 105-c and user equipment 115-c in accordance with various embodiments. Different aspects of system 300, such as the user equipment 115-c and/or the base stations 105-c, may be configured for control information processing and utilization in system 300 that may utilize multiple carriers including one or more flexible bandwidth carriers.

Transmissions 305-a and/or 305-b between the user equipment 115-c and the base station 105-a may utilize normal and/or flexible bandwidth waveforms that may be generated to occupy less (or more) bandwidth than a normal waveform. For example, at a band edge, there may not be enough available spectrum to place a normal waveform. For a flexible bandwidth waveform, as time gets dilated, the frequency occupied by a waveform goes down, thus making it possible to fit a flexible bandwidth waveform into spectrum that may not be broad enough to fit a normal waveform. In some embodiments, the flexible bandwidth waveform may be scaled utilizing a scaling factor N with respect to a normal waveform. Scaling factor N may take on numerous different values including, but not limited to, integer values such as 1, 2, 3, 4, 8, etc. N, however, does not have to be an integer. In some cases, transmissions 305-a may be with respect to a primary serving cell and transmission 305-b may be with respect to a secondary serving cell. In other cases, transmissions 305-a and 305-b may between a single antenna of a user equipment 115-c and the same or different antennas of the base station 105-a.

Different aspects of system 300, such as the user equipment 115-c, may be configured for receiving control information over a first channel of one of the one or more flexible bandwidth carriers. The user equipment 115-c may be configured for determining a processing time for the received control information over the first channel of the one of the one or more flexible bandwidth carriers based on a processing time of control information for a normal bandwidth carrier or another flexible bandwidth carrier. The user equipment 115-c may also be configured for utilizing the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers. At least the first carrier or the second carrier may include at least one of the one or more flexible bandwidth carriers.

In some embodiments, the base stations 105-c may also either in conjunction with or in place of the user equipment 115-c, perform some or all of the functionality described in reference to FIG. 3.

In some embodiments, the user equipment 115-c may be configured for receiving the control information for the normal bandwidth carrier or the other flexible bandwidth carrier over a channel of the normal bandwidth carrier or the other flexible bandwidth carrier. The user equipment 115-c may utilize the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In some embodiments, the user equipment 115-c may be configured for receiving control information over a second channel of one of the one or more flexible bandwidth carriers. The user equipment 115-c may determine a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers. The user equipment 115-c may also utilize the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

In some embodiments, the user equipment 115-c may be configured for determining at least a system frame number for applying the received control information based on a bandwidth scaling factor of the first channel of one of the one or more flexible bandwidth carriers, as part of determining the processing time for the received control information over the first channel of the one of the one or more flexible bandwidth carriers. In some cases, the processing time for the received control information over the first channel of the one of the one or more flexible bandwidth carriers may equal the processing time of the control information for the normal bandwidth carrier or the other flexible bandwidth carrier. In other cases, the processing time for the received control information over the first channel of the one of the one or more flexible bandwidth carriers may be less than a dilated processing time, which may be less than a theoretical processing time, for the received control information over the first channel of the one of the one or more flexible bandwidth carriers. In some cases, the processing time for the received control information over the first channel of the one of the one or more flexible bandwidth carriers may be undilated with respect to the processing time for a normal bandwidth carrier or another flexible bandwidth carrier.

In some embodiments, the control information over the first channel of one of the one or more flexible bandwidth carriers may include one or more grants, such as for the user equipment 115-c to apply. In some cases, the first channel of the one of the one or more flexible bandwidth carriers may include one of an Enhanced Absolute Grant Channel (E-AGCH) or Enhanced Relative Grant Channel (E-RGCH). In some cases, the one of the one or more flexible bandwidth carriers may utilize a bandwidth scaling factor equal to 2 or 4.

System 300 may be an example of a multicarrier HSPA/HSPA+ network, such as a multicarrier High Speed Downlink Packet Access (HSDPA) network that may utilize a primary serving High Speed Downlink Shared Channel (HS-DSCH cell) with a normal chip rate, such as 3.84 Mcps (e.g., N=1) and a secondary serving HS-DSCH cell(s) that may utilize a time dilated chip rate=3.84/2 Mcps (e.g., N=2) or 3.84/4 Mcps (e.g., N=4) or vice versa. Tools and techniques provided may support alignment of control information processing time and utilization between carriers having different chip rates, such as between the primary serving HS-DPCCH cell (which may be N=1) and secondary serving HS-DPCCH cell(s) (which may utilize a flexible bandwidth carrier, such as with N=2 or N=4), vice versa, and/or between a primary serving HS-DPCCH cell (which may have N=2) and a secondary serving HS-DPCCH cell (which may have N=4). In some cases, this may be accomplished by allotting a time period for control information processing that is greater than a minimum required processing time, such as for a normal bandwidth carrier or another flexible bandwidth carrier. In some cases, the determined control information processing time for the flexible bandwidth carrier may be equal to an un-dilated processing time for a normal bandwidth carrier. Subsequent to a determined processing time, the control information, which may include one or more grants, may be applied during the first TTI following the end of the determined and/or minimum required processing time.

Some embodiments may utilize additional terminology. A new unit D may be utilized. The unit D is dilated. The unit is unitless and has the value of N. One can talk about time in the flexible system in terms of “dilated time”. For example, a slot of say 10 ms in normal time may be represented as 10 Dms in flexible time (note: even in normal time, this will hold true since N=1 in normal time: D has a value of 1, so 10 Dms=10 ms). In time scaling, one can replace most “seconds” with “dilated-seconds.” Note frequency in Hertz is 1/s.

As discussed above, a flexible bandwidth or scalable bandwidth waveform may be a waveform that occupies less bandwidth than a normal waveform. Thus, in a flexible bandwidth system, the same number of symbols and bits may be transmitted over a longer duration compared to normal bandwidth system. This may result in time stretching, whereby slot duration, frame duration, etc., may increase by a scaling factor N. Scaling factor N may represent the ratio of the normal bandwidth to flexible bandwidth (BW). Thus, data rate in a flexible bandwidth system may equal (Normal Rater 1/N), and delay may equal (Normal Delay×N). In general, a flexible systems channel BW=channel BW of normal systems/N. Delay×BW may remain unchanged. Furthermore, in some embodiments, a flexible bandwidth waveform may be a waveform that occupies more bandwidth than a normal waveform. Scaling factor N may also be referred to as a bandwidth scaling factor.

Throughout this specification, the term normal system, subsystem, and/or waveform may be utilized to refer to systems, subsystems, and/or waveforms that involve embodiments that may utilize a scaling factor that may be equal to one (e.g., N=1) or a normal or standard chip rate. These normal systems, subsystems, and/or waveforms may also be referred to as standard and/or legacy systems, subsystems, and/or waveforms. Furthermore, flexible systems, subsystems, and/or waveforms may be utilized to refer to systems, subsystems, and/or waveforms that involve embodiments that may utilize a scaling factor that may be not equal to one (e.g., N=2, 4, 8, ½, ¼, etc.). For N>1, or if a chip rate is decreased, the bandwidth of a waveform may decrease. Some embodiments may utilize scaling factors or chip rates that increase the bandwidth. For example, if N<1, or if the chip rate is increased, then a waveform may be expanded to cover bandwidth larger than a normal waveform. Some embodiments may utilize a chip rate divisor (Dcr) to change the chip rate in some embodiments. Flexible systems, subsystems, and/or waveforms may also be referred to as scalable systems, subsystems, and/or waveforms in some cases. Flexible systems, subsystems, and/or waveforms may also be referred to as fractional systems, subsystems, and/or waveforms in some cases. Fractional systems, subsystems, and/or waveforms may or may not change bandwidth, for example. A fractional system, subsystem, or waveform may be flexible because it may offer more possibilities than a normal or standard system, subsystem, or waveform (e.g., N=1 system). Furthermore, the use of the term flexible may also be utilized to mean flexible bandwidth capable.

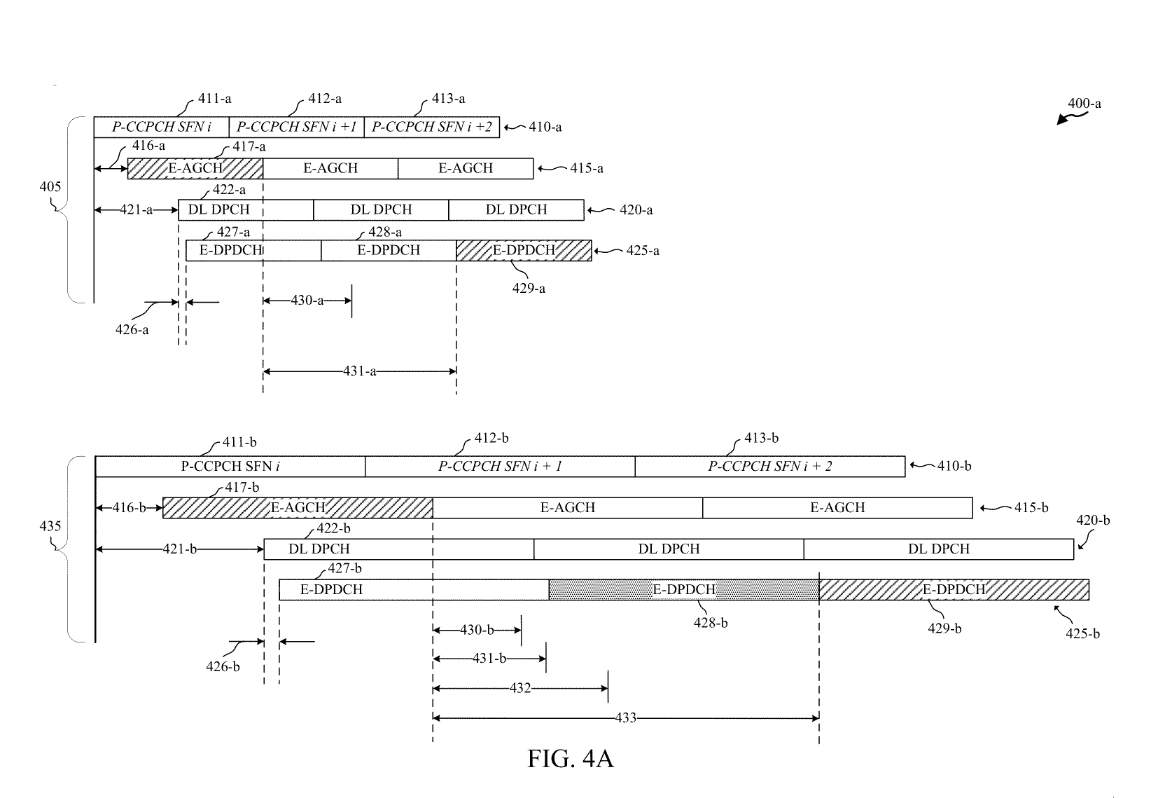

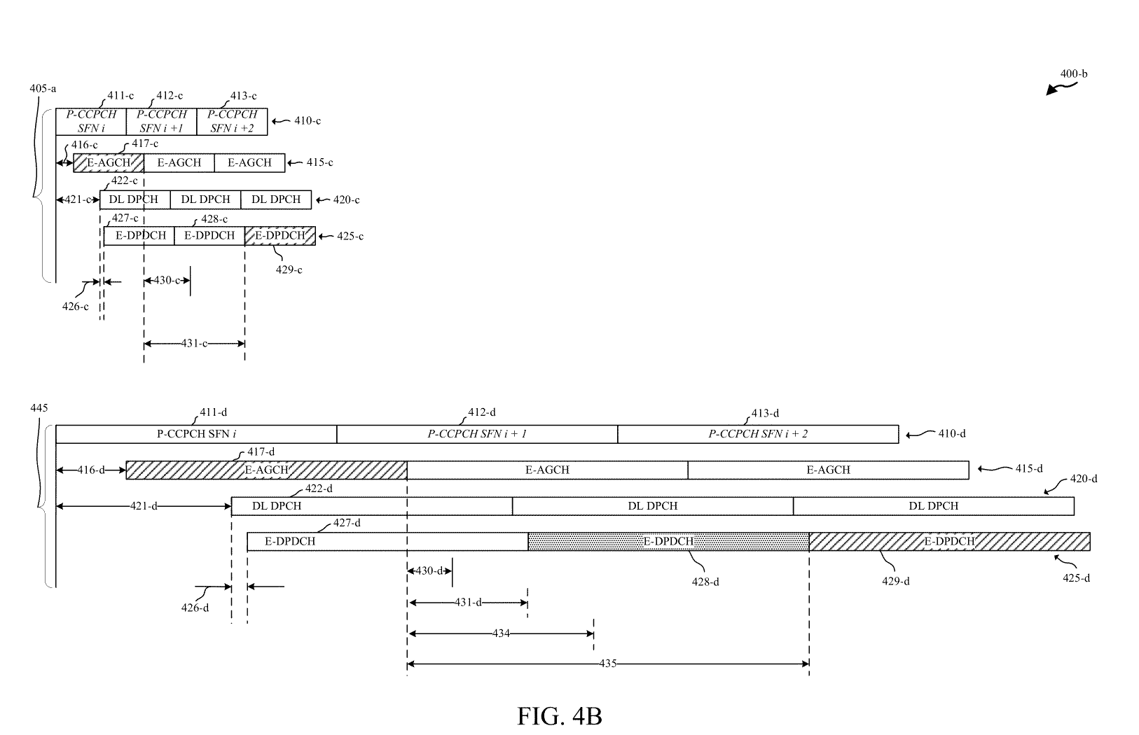

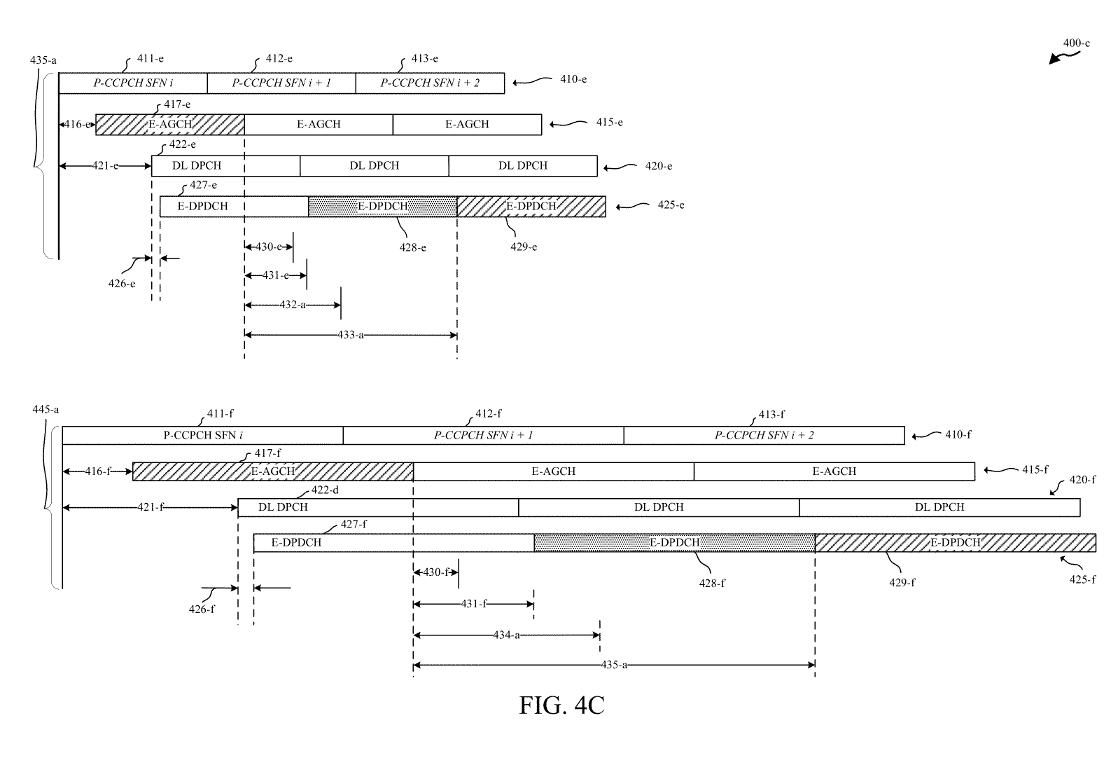

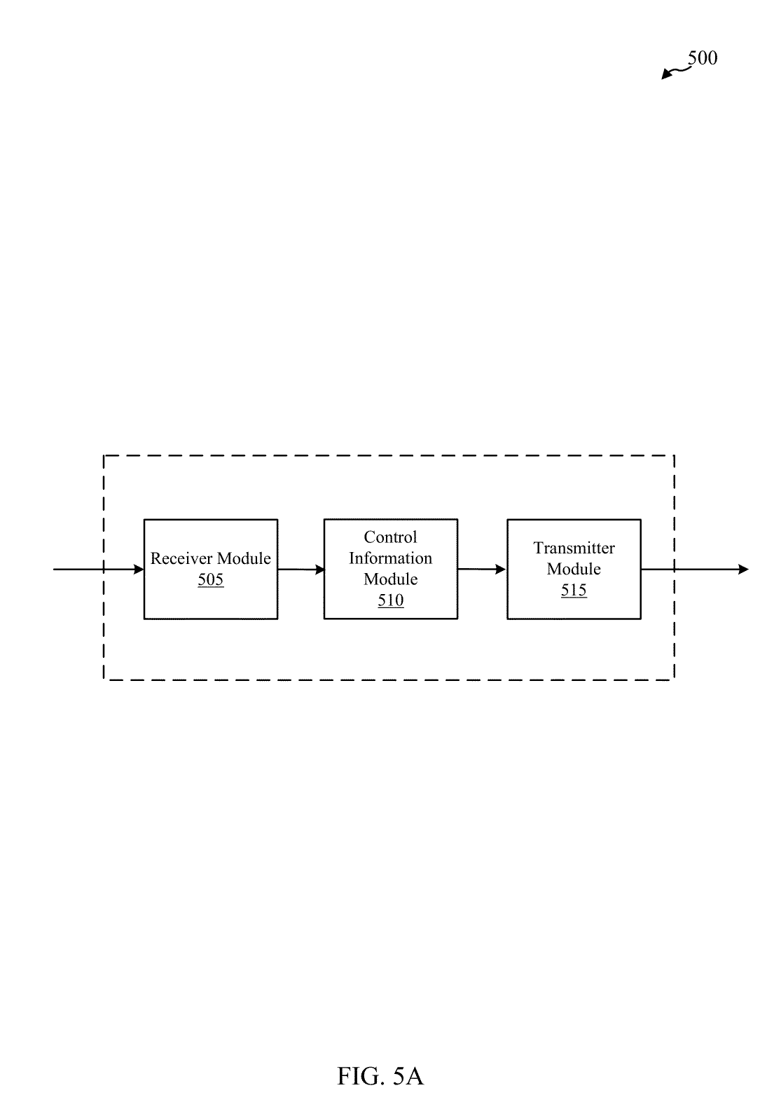

Turning next to FIGS. 4A-4C, control information processing and utilization timing diagrams illustrate multiple configuration 400, including configurations 400-a, 400-b, and 400-c that each include control information processing and utilization functionality in a multicarrier system that utilizes one or more flexible bandwidth carriers in accordance with various embodiments. The control information processing and utilization timing diagrams may be examples of control information methods, such as control information processing and utilization, implemented by various wireless entities, including all or part of: the base stations 105 of FIG. 1, FIG. 2A, FIG. 2B, and FIG. 3; the user equipment 115 of FIG. 1, FIG. 2A, FIG. 2B, FIG. 3; and/or the controller 120/core network 130 of FIG. 1. The common aspects between FIGS. 4A-4C will be described generally, and the particulars of each FIG. will then be described separately.

In some embodiments, configurations 400 may be implemented in a wireless communication system utilizing High-Speed Uplink Packet Access (HSUPA), particularly in a Scalable Universal Mobile Telecommunications System (S-UMTS). Multiple carriers may be utilized in a S-UMTS HSUPA configured system with some carriers having different bandwidth scaling factors than other carriers. For example, a normal bandwidth carrier 405 may having a bandwidth scaling factor of N=1. In addition, other carriers used in the S-UMTS HSUPA system, such as carriers 435, 445 may have different bandwidth scaling factors, such as N=2 or N=4.

Each carrier 405, 435, 445 may include multiple channels for communicating and processing various signaling, such as signaling including control information. The multiple channels may include a Primary Common Control Physical Channel (P-CCPCH) 410, an Absolute Grant Channel (E-AGCH) 415, a Downlink Dedicated Physical Channel (DL-DPCH) 420, and an Enhanced Dedicated Physical Data Channel (E-DPDCH) 425, for example. The E-AGCH 415 may receive Enhanced Dedicated Channel (E-DCH) control data, such as one or more grants, in multiple E-AGCH frames, such as in E-AGCH frame 417. The control information communicated in E-AGCH frame 417 may be processed during a required processing time 430, 432, 434 and utilized in a subsequent E-DPDCH frame, such as E-DPDCH frame 428 or E-DPDCH frame 429. The time between the full receipt of the E-AGCH frame 417 and the utilization of the control information communicated in the E-AGCH frame 417 may be defined as a utilization time 431.

The timing of each frame across the P-CCPCH 410, E-AGCH 415, DL-DPCH 420, and the E-DPDCH 425 may be relative to a system frame number (SFN) in a higher layer channel, such as the P-CCPCH 410. The length of the SFN may define and/or relate to a Transmission Time Interval (TTI) for the corresponding E-DCH for each carrier. The P-CCPCH 410 may be defined by multiple frames and/or SFNs, such as P-CCPCH SFN i 411, P-CCPCH SFN i+1 412, and P-CCPCH SFN i+2 413. The E-AGCH frame 417 may begin a delay 416 after the beginning of a P-CCPCH SFN i 411, which may be equal to 2 slots. A DL DPCH frame 422, which may be used to carry other relevant downlink information, for example, may begin a time τ_{DPCH} 421, which may be equal to 70*256 chips for N=1, N=2, and/or N=4 carriers, after the beginning of the P-CCPCH SFN i 411. A first E-DPDCH frame 427 may begin a time 426 after the beginning of the E-DPDCH frame 422. In some cases, time 426 may be equal to 1024 chips.

From these relationships, the required processing time 432, 434 for flexible bandwidth carriers 435, 445 having bandwidth scaling factors of N=2 and N=4 may be determined based on the require processing time 430 for the normal bandwidth carrier 405 having N=1. In some embodiments, the required processing time 432, 434 may be the minimum required processing time for the control information communicated over the E-AGCH 415, such as in the E-AGCH frame 417. In some cases, the required processing time 432, 434 may be undilated relative to the timing of flexible bandwidth carriers 435 and 445. By undilating the required processing time 432, 434 for the flexible bandwidth carriers 435 and 445, the processed control information may be utilized and applied in the following TTI, which may correspond to the next P-CCPCH SFN frame, such as P-CCPCH SFN i+1 412 via an E-DPDCH frame, such an E-DPDCH frame 428.

The TTI length of the E-DCH may determine how the required processing time 430, 432, 434 and the corresponding control information utilization times 431, 433, 435 may be determined for carriers having different bandwidth scaling factors, such as N=1, N=2, and/or N=4. The following are given only as examples. The claimed subject matter is not so limited however, and may include other TTI lengths.

In some embodiments, the SFN's of one or cells 405, 410 may increment by 1, 2, or 4, or any other value. In some cases, the SFN's may be relative to an N=1 cell, such that each SFN for a normal bandwidth carrier increments by one. For a N=2 carrier, in order to align with an N=1 carrier, each SFN on the N=2 carrier may increment by two. For a N=4 carrier, in order to align with an N=1 carrier, each SFN on the N=4 carrier may increment by four. In other cases, the SFN's may be relative to an N=2 cell, such that each SFN increments by two, or relative to a N=4 cell, such that each SNF increments by 4. In other embodiments, SFN's for an N=1 cell, or a n N=2 or 4 cell, may only utilize even or odd numbers.

In some cases, a SFN for a carrier, such as the normal carrier 405, may not completely align or be numbered the same as another carrier, such as flexible bandwidth carrier 410, or vice versa. However, for ease of understanding, FIGS. 4A-4C show CFN's for multiple carriers as aligned. It should be appreciated that the claimed subject matter is not so limited.

The UE 115 may receive E-DCH control data over the E-AGCH 415, with the TTI of the corresponding E-DCH equal to 10 ms, for example. The UE 115 may first take into account E-DCH control data received in the E-AGCH frame 417 associated with P-CCPCH SFN i 411 over the P-CCPCH 410 in the higher layer procedures which may correspond to E-DCH transmission in the E-DPDCH frame associated a next P-CCPCH SFN i+1+s, which may be E-DPDCH frame 428 beginning in P-CCPCH SFN i+1 412 or E-DPDCH frame 429 beginning in P-CCPCH SFN i+2 413. The value s of P-CCPCH SFN i+1+s may be defined by the following:

$$s = ⌈ \frac{80 / N + 20 - ( {τ}_{DPCH , n} / 256 )}{150} ⌉ ; \\ where N = 1 , 2 or 4 \qquad ( 1 )$$

Equation (1) may be used to determine in which P-CCPCH SFN, and hence in which E-DPCH frame, the control information contained in E-AGCH frame 417 will be utilized, over multiple carriers having different bandwidth scaling factors, such as carrier 405 with N=1, carrier 435 with N=2, or carrier 445 with N=4. Based on the determined P-CCPCH SFN for multiple flexible carriers having different bandwidth scaling factors, the processing times 430, 432, 434 and hence the utilization times 431, 433, 435 of the multiple flexible bandwidth carriers may be aligned across the multiple different flexible bandwidth carriers to increase control information processing and utilization efficiency.

In other embodiments, the UE 115 may receive E-DCH control data over the E-AGCH 415, with the TTI of the corresponding E-DCH equal to 2 ms, for example. The UE 115 may first take into account E-DCH control data received in subframe j of the E-AGCH frame 417 associated with P-CCPCH SFN i 411 over the P-CCPCH 410 in the higher layer procedures which may correspond to E-DCH transmission in sub-frame t of the E-DPDCH frame associated a next P-CCPCH SFN i+s, such as E-DPDCH frame 428 beginning in P-CCPCH SFN i+1 412 or E-DPDCH frame 429 beginning in P-CCPCH SFN i+2 413. The value s of P-CCPCH SFN i+s may be defined by the following:

$$s = ⌊ \frac{⌈ \frac{30 j + 50 / N + 50 - ( {τ}_{DPCH , n} / 256 )}{30} ⌉}{5} ⌋ ; \\ where N = 1 , 2 or 4 \qquad ( 2 )$$

And the subframe t of the E-DPDCH frame in which the control information may be utilized may be determined by the following:

$$t = ⌈ \frac{30 j + 50 / N + 50 - ( {τ}_{DPCH , n} / 256 ) - 150 s}{30} ⌉ ; \\ where N = 1 , 2 or 4 \qquad ( 3 )$$

Equation (2) may be used to determine in which P-CCPCH SFN, and hence in which E-DPDCH frame, the control information contained in E-AGCH frame 417 will be utilized, over multiple carriers having different bandwidth scaling factors, such as carrier 405 with N=1, carrier 435 with N=2, or carrier 445 with N=4. Equation (3) may be used to determine more particularly in which subframe t of the determined E-DPDCH frame, the control information will be utilized. Based on the determined P-CCPCH SFN, E-DPDCH frame, and subframe t of that E-DPDCH frame for multiple flexible carriers having different bandwidth scaling factors, the processing times 430, 432, 434 and hence the utilization times 431, 433, 435 of the multiple flexible bandwidth carriers may be aligned across the multiple different flexible bandwidth carriers to increase control information processing and utilization efficiency.

In some embodiments, a UE 115 which does not belong to the serving E-DCH radio link set may receive control information which may include one or more grants, over a Relative Grant Channel (E-RGCH) (not shown in FIGS. 4A-4C, as the timing relations depicted in FIGS. 4A-4C are generally applicable to an E-RGCH replacing the E-AGCH 415). Just as descried above with respect to control information received over the E-AGCH 415, different TTIs associated with the E-DCH may change the timing relations and the required control information processing times of carriers having different bandwidth scaling factors for the E-RGCH.

In some embodiments, the UE 115 may receive E-DCH control data over the E-RGCH, with the TTI of the corresponding E-DCH equal to 10 ms, for example. The UE 115 may first take into account E-DCH control data received in an E-RGCH frame associated with P-CCPCH SFN i 411 over the P-CCPCH 410 in the higher layer procedures which may correspond to E-DCH transmission in the E-DPDCH frame associated a next P-CCPCH SFN i+1+s, which may be E-DPDCH frame 428 beginning in P-CCPCH SFN i+1 412 or E-DPDCH frame 429 beginning in P-CCPCH SFN i+2 413. The value s of P-CCPCH SFN i+1+s may be defined by the following:

$$s = ⌈ \frac{140 / N + 20 - ( {τ}_{DPCH , n} / 256 )}{150} ⌉ ; \\ where N = 1 , 2 or 4 \qquad ( 4 )$$

Equation (4) may be used to determine in which P-CCPCH SFN, and hence in which E-DPCH frame, the control information contained in the E-RGCH frame will be utilized, over multiple carriers having different bandwidth scaling factors, such as carrier 405 with N=1, carrier 435 with N=2, or carrier 445 with N=4. Based on the determined P-CCPCH SFN for multiple flexible carriers having different bandwidth scaling factors, the processing times 430, 432, 434 and hence the utilization times 431, 433, 435 of the multiple flexible bandwidth carriers may be aligned across the multiple different flexible bandwidth carriers to increase control information processing and utilization efficiency.

In other embodiments, the UE 115 may receive E-DCH control data over the E-RGCH, with the TTI of the corresponding E-DCH equal to 2 ms, for example. The UE 115 may first take into account E-DCH control data received in an E-RGCH frame associated with P-CCPCH SFN i 411 over the P-CCPCH 410 in the higher layer procedures which may correspond to E-DCH transmission in sub-frame t of the E-DPDCH frame associated a next P-CCPCH SFN i+s, such as E-DPDCH frame 428 beginning in P-CCPCH SFN i+1 412 or E-DPDCH frame 429 beginning in P-CCPCH SFN i+2 413. The value s of P-CCPCH SFN i+s may be defined by the following:

$$s = ⌊ \frac{⌈ \frac{140 / N + 20 - ( {τ}_{DPCH , n} / 256 )}{30} ⌉}{5} ⌋ ; \\ where N = 1 , 2 or 4 \qquad ( 5 )$$

And the subframe t of the E-DPDCH frame in which the control information may be utilized may be determined by the following:

$$t = ⌈ \frac{140 / N + 20 - ( {τ}_{DPCH , n} / 256 ) - 150 s}{30} ⌉ ; \\ where N = 1 , 2 or 4 \qquad ( 6 )$$

Equation (5) may be used to determine in which P-CCPCH SFN, and hence in which E-DPDCH frame, the control information contained in the E-RGCH frame will be utilized, over multiple carriers having different bandwidth scaling factors, such as carrier 405 with N=1, carrier 435 with N=2, or carrier 445 with N=4. Equation (6) may be used to determine more particularly in which subframe t of the determined E-DPDCH frame, the control information will be utilized. Based on the determined P-CCPCH SFN, E-DPDCH frame, and subframe t of that E-DPDCH frame for multiple flexible carriers having different bandwidth scaling factors, the processing times 430, 432, 434 and hence the utilization times 431, 433, 435 of the multiple flexible bandwidth carriers may be aligned across the multiple different flexible bandwidth carriers to increase control information processing and utilization efficiency.

With specific reference to FIG. 4A, a control information processing and utilization timing diagram 400-a depicts a normal bandwidth carrier (N=1) 405 and a flexible bandwidth carrier (N=2) 435. All of the relationship described above with respect to the various channels including timing relations apply to both carrier 405 and 435, with the only difference being that in time, every frame and time period for carrier 435 is twice as long as for carrier 405, such that each frame length of each of the P-CCPCH 410-b, the E-AGCH 415-b, the DL DPCH 420-b, and the E-DPDCH 425-b is twice as long as each frame of the P-CCPCH 410-a, the E-AGCH 415-a, the DL DPCH 420-a, and the E-DPDCH 425-a over carrier 405. For example, frames 411-b, 412-b, 413-b, 417-b, 422-b, 427-b, 428-b, and 429-b associated with carrier 435 may be twice as long in time than frames 411-a, 412-a, 413-a, 417-a, 422-a, 427-a, 428-a, and 429-a associated with carrier 405. Furthermore, delay times 416-b, 421-b, and 426-b of carrier 435 may also be twice as long as delay times 416-a, 421-a, and 426-a of carrier 405. Thus the timing relationships between the various frames across the various channels of carrier 435 are the same as for carrier 405, except scaled by a factor of 2.

In some embodiments, an E-AGCH frame 417-a received over E-AGCH 415-a in carrier 405 having N=1, may carry control information, such as one or more grants, that may be utilized over the E-DPDCH 425-a. In order to utilize this control information communicated in E-AGCH frame 417-a, the control information may be processed, such as during required processing time 430-a. The processed control information may then be utilized over the E-DPDCH 425-a in a next E-DPDCH frame, such as E-DPDCH frame 429-a, after a utilization time 431-a. Utilization time 431-a may be determined based on the required processing time 430-a. E-DPDCH frame 429-a may begin in P-CCPCH SFN i+2 413-a, which may be determined by Equation (1) or Equations (2) and (3) above, depending on which TTI value is implemented across the E-DCH. In some cases, if the control information is communicated via an E-RGCH, Equation (4) or Equations (5) and (6) may also be used to determine the relative staring P-CCPCH SFN across the P-CCPCH 410-a.

As carrier 405 is not dilated, i.e. N=1, the required processing time 430-a may be used as the minimum required processing time for other carriers having different flexible bandwidths, such as carrier 435 having N=2. Because carrier 435 is dilated by a factor of 2 with respect to carrier 405, a dilated processing time 432 of control information communicated in an E-AGCH frame 417-b and subsequent to communication of the E-AGCCH frame 417-b, may be twice as long as the required processing time 430-a for a normal bandwidth carrier, which is shown right next to the dilated processing time 432, as required processing time 430-b. Because the dilated processing time 432 for carrier 435 is twice as long, the E-DPDCH frame 428-b may not be utilized to apply the control information communicated in E-AGCH frame 417-b. Rather, the E-DPDCH frame 429-b may be used as the dilated processing time 432 ends in the middle of E-DPDCH frame 428-b, thus increasing the dilated utilization time 433. However, by configuring the dilated processing time 432 and thus the subsequent dilated utilization time 433 to correspond to the required processing time 430-b and the subsequent utilization time 431-b, for example by undilating these values, the dilated utilization time 433 may be decreased to the utilization time 431-b. This may further be accomplished by determining the P-CCPCH SFN on the P-CCPCH 410-b over which the control information may be utilized via Equations (1) or (2) and (3), depending on what value of TTI is used across the E-DCH. By undilating the dilated processing time 433 for carrier 435, the control information, which may include one or more grants, may be applied 1 frame earlier across the E-DPDCH 425-b, than if the dilated processing time 432 remained dilated. Further advantages may also be realized by decreasing the required processing time over flexible bandwidth carriers (dilated) to correlate with the required processing time over a normal bandwidth carrier (undilated), such as increases in overall system efficiency due to decreased control information delays, such as grant processing and utilization.

With specific reference to FIG. 4B, a control information processing and utilization timing diagram 400-b depicts a normal bandwidth carrier (N=1) 405-a and a flexible bandwidth carrier (N=4) 445. All of the relationships described above with respect to the various channels including timing relations may apply to both carrier 405-a and 445, with the only difference being that in time, every frame and time period for carrier 445 is 4 times as long as for carrier 405-a, such that each frame length of each of the P-CCPCH 410-d, the E-AGCH 415-d, the DL DPCH 420-d, and the E-DPDCH 425-d is four times as long as each frame of the P-CCPCH 410-c, the E-AGCH 415-c, the DL DPCH 420-c, and the E-DPDCH 425-c over carrier 405-a. For example, frames 411-d, 412-d, 413-d, 417-d, 422-d, 427-d, 428-d, and 429-d associated with carrier 445 may be four times as long in time than frames 411-c, 412-c, 413-c, 417-c, 422-c, 427-c, 428-c, and 429-c associated with carrier 405-a. Furthermore, delay times 416-d, 421-d, and 426-d of carrier 445 may also be four times as long as delay times 416-c, 421-c, and 426-c of carrier 405-a. Thus the timing relationships between the various frames across the various channels of carrier 445 are the same as for carrier 405-a, except scaled by a factor of 4.

For example, an E-AGCH frame 417-c received over E-AGCH 415-c in carrier 405-a having N=1, may carry control information, such as one or more grants, that may be utilized over the E-DPDCH 425-c. In order to utilize this control information communicated in E-AGCH frame 417-c, the control information may be processed, such as during required processing time 430-c. The processed control information may then be utilized over the E-DPDCH 425-c in a next E-DPDCH frame, such as E-DPDCH frame 429-c, after a utilization time 431-c. Utilization time 431-c may be determined based on the required processing time 430-c. E-DPDCH frame 429-c may correspond to P-CCPCH SFN i+2 413-c, which may be determined by Equation (1) or Equations (2) and (3) above, depending on which TTI value is implemented across the E-DCH. In some cases, if the control information is communicated via an E-RGCH, Equation (4) or Equations (5) and (6) may be also used.

As carrier 405-a is not dilated, i.e. N=1, the required processing time 430-c may be used as the minimum required processing time for other carriers having different flexible bandwidths, such as carrier 445 having N=4. Because carrier 445 is dilated by a factor of 4 with respect to carrier 405-a, a dilated processing time 434 of control information communicated in an E-AGCH frame 417-d may be 4 times as long as the required processing time 430-c for a normal bandwidth carrier, which is shown right next to the dilated processing time 434, as required processing time 430-d. Because the dilated processing time 434 for carrier 445 is 4 times as long, the E-DPDCH frame 428-d may not be utilized to apply the control information communicated in E-AGCH frame 417-d. Rather, the E-DPDCH frame 429-d may be used as the dilated processing time 434 ends in the middle of E-DPDCH frame 428-d, thus increasing the dilated utilization time 435. However, by configuring the dilated processing time 434 and thus the subsequent dilated utilization time 435 to correspond to the required processing time 430-d and the subsequent utilization time 431-d, by for example by undilating these values, the dilated utilization time 435 may be decreased to the utilization time 431-d. This may further be accomplished by determining the SFN on the P-CCPCH 425-d over which the control information may be utilized via Equation (1) or Equations (2) and (3), depending on what value of TTI is used across the E-DCH. By undilating the dilated processing time 435 for carrier 445, the control information, which may include one or more grants, may be applied 1 frame earlier across the E-DPDCH 425-d than if the dilated processing time 434 remained dilated. Further advantages may also be realized by decreasing the required processing time over a flexible bandwidth carrier to correlate with the required processing time over a normal bandwidth carrier, such as increases in overall system efficiency.

With specific reference to FIG. 4C, a control information processing and utilization timing diagram 400-c depicts a first flexible bandwidth carrier (N=2) 435-a, and a second flexible bandwidth carrier (N=4) 445-a. All of the relationship described above with respect to the various channels including timing relations may apply to carriers 435-a and 445-a, with the only difference being that in time, every frame and time period for carrier 445-a is 2 times as long as for carrier 435-a, such that each frame length of each of the P-CCPCH 410-f, the E-AGCH 415-f, the DL DPCH 420-f, and the E-DPDCH 425-f is 2 times as long as each frame of the P-CCPCH 410-e, the E-AGCH 415-e, the DL DPCH 420-e, and the E-DPDCH 425-e over carrier 435-a. For example, frames 411-f, 412-f, 413-f, 417-f, 422-f, 427-f, 428-f, and 429-f associated with carrier 445-a may be 2 times as long in time than frames 411-e, 412-e, 413-e, 417-e, 422-e, 427-e, 428-e, and 429-e associated with carrier 435-a. Furthermore, delay times 416-f, 421-f, and 426-f of carrier 445-a may also be 2 times as long as delay times 416-e, 421-e, and 426-e of carrier 435-a. Thus the timing relationships between the various frames across the various channels of carrier 445-a are the same as for carrier 435-a, except scaled by a factor of 2 with respect to carrier 435-a.

In some embodiments, in addition to aligning a required processing time 430 of a normal bandwidth carrier, such as carrier 405, with a dilated processing time of a flexible bandwidth carrier, the dilated processing times of two different flexible bandwidth carriers may be aligned/configured based on a required processing time (undilated) of a normal bandwidth carrier. For example, a dilated processing time 432-a of a flexible bandwidth carrier 435-a having N=2, may be aligned with the dilated processing time 434-a of another flexible bandwidth carrier 445-a having N=4, based on a required processing time 430-e, 430-f (undilated), of a normal bandwidth carrier having N=1, such as carrier 405 (not shown).

In particular, an E-AGCH frame 417-e received over E-AGCH 415-e of carrier 435-a having N=2, may carry control information, such as one or more grants, that may be utilized over the E-DPDCH 425-e. In order to utilize this control information communicated in E-AGCH frame 417-e, the control information may be processed, such as during a dilated processing time 432-a. The processed control information may then be utilized over the E-DPDCH 425-e in the next E-DPDCH frame, such as E-DPDCH frame 429-e, after a utilization time 433-a. Utilization time 433-a may be determined based on the required processing time 432-a. E-DPDCH frame 429-e may correspond to P-CCPCH SFN i+2 413-e, which may be determined by Equation (1) or Equations (2) and (3) above, depending on which TTI value is implemented across the E-DCH. In some cases, if the control information is communicated via an E-RGCH, Equation (4) or Equations (5) and (6) may be used.

The required processing time 430-e, corresponding to a normal bandwidth carrier such as carrier 405, may be used as the minimum required processing time for other carriers having different flexible bandwidths, such as carrier 435-a having N=2 and carrier 445-a having N=4. Because carrier 435-a is dilated by a factor of 2, a dilated processing time 432-a of control information communicated in an E-AGCH frame 417-e may be twice as long as the required processing time 430-e for a normal bandwidth carrier, which is shown right next to the dilated processing time 432-a. Because the dilated processing time 432-a for carrier 435-a is twice as long, the E-DPDCH frame 428-e beginning in PCCPCH SFN i+1 413-e may not be utilized to apply the control information communicated in E-AGCH frame 417-e. Rather, the E-DPDCH frame 429-e beginning in PCCPCH SFN i+2 413-e may be used as the dilated processing time 432-a ends in the middle of E-DPDCH frame 428-b, thus increasing the dilated utilization time 433-a.

Furthermore, carrier 445-a is dilated by a factor of 4 resulting in a dilated processing time 434-a of control information communicated in an E-AGCH frame 417-f being 4 times as long as the required processing time 430-f for a normal bandwidth carrier, which is shown next to the dilated processing time 434-a. Because the dilated processing time 434-a for carrier 445-a is 4 times as long, the E-DPDCH frame 428-e beginning in PCCPCH SFN i+1 413-f may not be utilized to apply the control information communicated in E-AGCH frame 417-f. Rather, the E-DPDCH frame beginning in PCCPCH SFN i+1 413-f 429-f may be used as the dilated processing time 434-a ends in the middle of E-DPDCH frame 428-e, thus increasing the dilated utilization time 435-a.

In some embodiments, by configuring the dilated processing times 432-a, 434-a and thus the subsequent dilated utilization times 433-a, 435-a to correspond to the required processing time 430-e, 430-f and the subsequent utilization time 431-e, 431-f, for example by undilating these values, the dilated utilization time 433-a, 435-a may be decreased to the utilization times 431-e, 431-f. Configuring the dilated processing time 434-a of carrier 445-a to match the required processing time 430-e, 430-f of a normal bandwidth carrier, may also be done in conjunction with configuring the dilated processing time 432-a of carrier 435-a to match the same required processing time 430-e, 430-f of a normal bandwidth carrier to realize control information processing and utilization synchronization and/or efficiency increases across multiple different flexible bandwidth carriers. This may further be accomplished by determining the SFN on the P-CCPCH 410-e, 410-f over which the control information may be utilized via Equation (1) or Equations (2) and (3), depending on what value of TTI is used across the E-DCH. By undilating the dilated processing time 432-a, 434-a for carriers 435-a and 445-a, the control information, which may include one or more grants, may be applied 1 frame earlier across the E-DPDCH 425-c, 425-d, such as in E-DPDCH 428-e, 428-f beginning in P-CCPCH SFN i+1 412-e, 412-f, than if the required processing time 432-a, 434-a remained dilated.

In other embodiments, the dilated processing time, such as time 432-a of carrier 435-a having N=2, may be used as the baseline to adjust a dilated processing time 434-a of carrier 445-a having N=4. This may result in the utilization time 435-a of carrier 445-a being reduced such that an E-DPDCH frame 428-f beginning in P-CCPCH SFN i+1 412-f may be used to apply the control information received in the E-AGCH frame 417-f instead of in the E-DPDCH frame 429-f beginning in P-CCPCH SFN i+2 413-f, thus reducing control information application delay. In some cases this may equate to the dilated utilization time 435-a over carrier 445-a being reduced to the dilated utilization time 433-a over carrier 435-a.

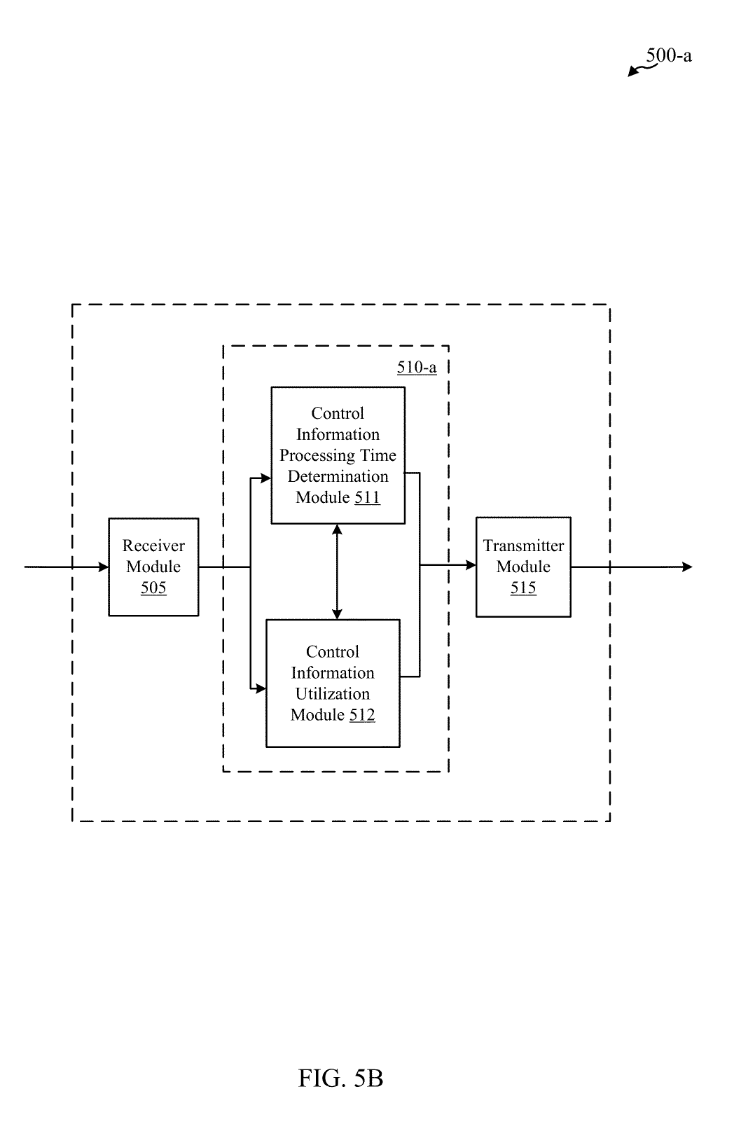

Turning next to FIG. 5A, a block diagram illustrates a device 500 that includes control information processing and utilization functionality in a multicarrier system that utilizes one or more flexible bandwidth carriers in accordance with various embodiments. The device 500 may be an example of the user equipment (UE) 115 of FIG. 1, FIG. 2A, FIG. 2B, and/or FIG. 3, configured to implement aspects of timing diagrams 400-a, 400-b, and/or 400-c, of FIGS. 4A, 4B, and/or 4C. In alternative embodiments, device 500 may be an example of aspects of: the base stations 105 of FIG. 1, FIG. 2A, FIG. 2B, and/or FIG. 3, and/or the controller 120/core network 130 of FIG. 1. The device 500 may include a receiver module 505, a control information module 510, and a transmitter module 515. Each of these components may be in communication with each other.

These components of the device 500 may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive information such as packet, data, and/or signaling information regarding what device 500 has received. The receiver module 505 may receive control information over a first channel of one of the one or more flexible bandwidth carriers. The received control information may be utilized by the device 500 for different purposes. The transmitter module 515 may transmit information such as packets, data, or signaling information regarding what device 500 has processed. The transmitted information may be utilized by various network entities for different purposes, as described below.

The control information module 510 may be configured to perform a method of control information processing and utilization, such as for optimizing timing relations between multiple carriers, in a multicarrier system that utilizes one or more flexible bandwidth carriers. For example, the control information module 510 may, upon communication of the received control information over a first channel of one of the one or more flexible bandwidth carriers from the receiver module 505, determine a processing time for the received control information over the first channel of the one of the one or more flexible bandwidth carriers based on a processing time of control information for a normal bandwidth carrier or another flexible bandwidth carrier. The control information module 510 may further utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers. At least the first carrier or the second carrier may include at least one of the one or more flexible bandwidth carriers.

In some cases, the control information module 510 may, upon determining or obtaining the processing time for the received control information, instruct, via transmitter module 515, another network device, such as a UE 115 or base station(s) 105, to utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

In some embodiments, the receiver module 505 may further be configured to receive the control information for the normal bandwidth carrier or the other flexible bandwidth carrier over a channel of the normal bandwidth carrier or the other flexible bandwidth carrier and communicate this control information to the control information module 510. The control information module 510 may then utilize the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier. In some cases, another network entity, such as a UE 115 or base station(s) 105 may be instructed to utilize the received control information for the normal bandwidth carrier or the other flexible bandwidth carrier as described above, via transmitter module 515.

In some embodiments, the receiver module 505 may further be configured to receive control information over a second channel of one of the one or more flexible bandwidth carriers and communicate this control information to the control information module 510. The control information module 510 may then determine a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers. The control information module 510 may further utilize the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers. In some cases, another network entity, such as a UE 115 or base station(s) 105 may be instructed to utilize the received control information for the second channel of the one of the one or more flexible bandwidth carriers as described above, via transmitter module 515.

In some embodiments, the control information module 510 may determine the processing time for the received control information over the first channel of the one of the one or more flexible bandwidth carriers, at least in part, by determining a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In some embodiments, the processing time for the received control information over the first channel of the one of the one or more flexible bandwidth carriers may be less than a dilated processing time, such as a theoretical dilated processing time, for the received control information over the first channel of the one of the one or more flexible bandwidth carriers.

In some cases, the processing time for the received control information over the first channel of the one of the one or more flexible bandwidth carriers may be undilated with respect to the processing time for control information over a normal bandwidth carrier or another flexible bandwidth carrier. In other words, this may equate to the processing time for the received control information over the first channel of the one of the one or more flexible bandwidth carriers, when adjusted, being un-dilated in relation to other signaling over the flexible bandwidth carrier.

In some embodiments, the control information over the first channel of one of the one or more flexible bandwidth carriers may include one or more grants. In some cases, the first channel of the one of the one or more flexible bandwidth carriers may include one of an Enhanced Absolute Grant Channel (E-AGCH) or Enhanced Relative Grant Channel (E-RGCH).

In some embodiments, the first carrier may be a normal bandwidth carrier and the second carrier may include be a flexible bandwidth carrier. In some embodiments, the first carrier may be a flexible bandwidth carrier and the second carrier may be a flexible bandwidth carrier different from the first carrier. In some cases, the flexible bandwidth of the first carrier may be greater than the flexible bandwidth of the second carrier. In some cases, the flexible bandwidth of the first carrier may be less than the flexible bandwidth of the second carrier.

In some embodiments, the first carrier may have a bandwidth scaling factor equal to 1 and the second carrier may have a bandwidth scaling factor equal to 2 or 4. In other embodiments, the first carrier may have a bandwidth scaling factor equal to 2 or 4, and the second carrier may have a bandwidth scaling factor equal to 4 or 2.

Turning next to FIG. 5B, a block diagram illustrates a device 500-a that includes control information processing and utilization functionality in a multicarrier system that utilizes one or more flexible bandwidth carriers in accordance with various embodiments. The device 500-a may be an example of aspects of the user equipment 115 of FIG. 1, FIG. 2A, FIG. 2B, and/or FIG. 3, and/or aspects of the controller 120/core network 130 of FIG. 1, configured to implement the timing diagrams 400-a, 400-b, and/or 400-c of FIGS. 4A, 4B, and/or 4C. In alternative embodiments, the device 500-a may be an example of: the base stations 105 of FIG. 1, FIG. 2A, FIG. 2B, and/or FIG. 3.

The device 500-a may include a receiver module 505, a control information processing time determination module 511, a control information utilization module 512, and a transmitter module 515. Each of these components may be in communication with each other. In some embodiments, the control information module 510-a, which may incorporate some or all aspects of the control information module 510 of FIG. 5A, may include the control information processing time determination module 511 and the control information utilization module 512. Device 500-a, which may be a UE 115, may include some or all aspects of, or may implement some or all of the functionality of, device 500 as described above in reference to FIG. 5A.

The components of the device 500-a may, individually or collectively, be implemented with one or more application-specific integrated circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

The receiver module 505 may receive information such as packet, data, and/or signaling information regarding what device 500-a has received. The receiver module 505 may receive control information over a first channel of one of the one or more flexible bandwidth carriers. The received control information may be utilized by the device 500-a for different purposes. The transmitter module 515 may transmit information such as packets, data, or signaling information regarding what device 500-a has processed. The transmitted information may be utilized by various network entities for different purposes as described herein.

The control information processing time determination module 511 may be configured to, upon communication of the received control information over a first channel of one of the one or more flexible bandwidth carriers from the receiver module 505, determine a processing time for the received control information over the first channel of the one of the one or more flexible bandwidth carriers based on a processing time of control information for a normal bandwidth carrier or another flexible bandwidth carrier. The control information processing time determination module 511 may then communication the determined processing time to the control information utilization module 512. The control information utilization module 512 may utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers. The transmitter module 515 may be configured to communicate some or all of the determined information, including control information processing time(s), to help coordinate control information processing and utilization across multiple carriers utilized by various network entities, such as by UE(s) 115 and base stations(s) 105. In some cases, at least the first carrier or the second carrier may include at least one of the one or more flexible bandwidth carriers.

In some embodiments, the receiver module 505 may further be configured to receive the control information for the normal bandwidth carrier or the other flexible bandwidth carrier over a channel of the normal bandwidth carrier or the other flexible bandwidth carrier and communication this control information to the control information module 510. The control information utilization module 512 may then utilize the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In some embodiments, the receiver module 505 may further be configured to receive control information over a second channel of one of the one or more flexible bandwidth carriers and communication this control information to the control information processing time determination module 511. The control information processing time determination module 511 may then determine a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers. The control information processing time determination module 511 may communicate the processing time for the received control information over the second channel to the control information utilization module 512. The control information utilization module 512 may then utilize the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

In some embodiments, the control information processing time determination module 511 may determine the processing time for the received control information over the first channel of the one of the one or more flexible bandwidth carriers, at least in part, by determining a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In some embodiments, the processing time for the received control information over the first channel of the one of the one or more flexible bandwidth carriers may be less than a dilated processing time, such as a theoretical dilated processing time, for the received control information over the first channel of the one of the one or more flexible bandwidth carriers.

In some cases, the processing time for the received control information over the first channel of the one of the one or more flexible bandwidth carriers may be undilated with respect to the processing time for control information over a normal bandwidth carrier or another flexible bandwidth carrier. In other words, this may equate to the processing time for the received control information over the first channel of the one of the one or more flexible bandwidth carriers, when adjusted, being un-dilated, or scaled by a factor of 2 or 4, in relation to other signaling over the flexible bandwidth carrier.

In some embodiments, the control information over the first channel of one of the one or more flexible bandwidth carriers may include one or more grants. In some cases, the first channel of the one of the one or more flexible bandwidth carriers may include one of an Enhanced Absolute Grant Channel (E-AGCH) or Enhanced Relative Grant Channel (E-RGCH). In some cases, the one of the one or more flexible bandwidth carriers may utilize a bandwidth scaling factor equal to 2 or 4.

In some embodiments, the control information processing time determination module 511 and/or the control information utilization module 512 may be located at a UE 115. The receiver module 505 and/or the transmitter module 515 may also be located at the UE 115. In other embodiments, the receiver module 505, the control information processing time determination module 511, the control information utilization module 512, and/or the transmitter module 15 may be located at different network entities, such as base station (s) 105, and may coordinate via the backhaul, air interfaces, etc.

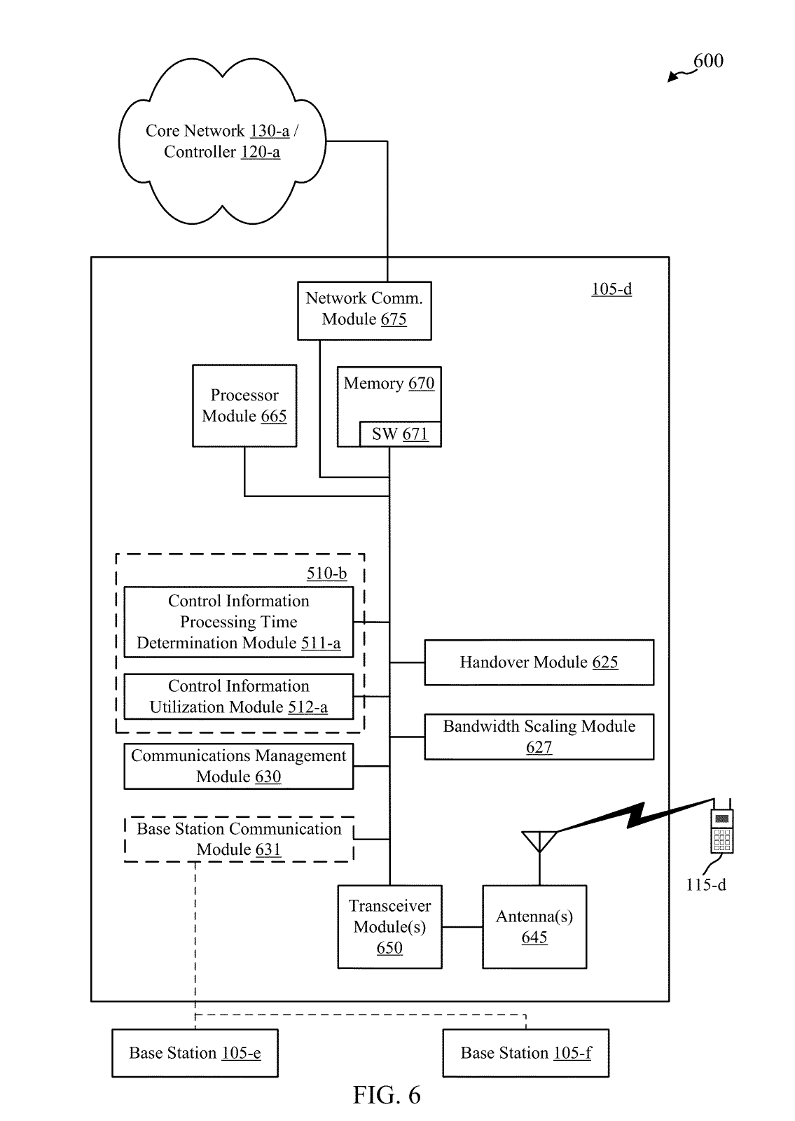

FIG. 6 shows a block diagram of a communications system 600 that may be configured for control information processing and utilization in a multicarrier system that utilizes one or more flexible bandwidth carriers in accordance with various embodiments. This system 600 may include aspects of the system 100 depicted in FIG. 1, systems 200-a and 200-b of FIGS. 2A and 2B, system 300 of FIG. 3, and/or systems 400-a, 400-b, and/or 400-c of FIGS. 4A, 4B, and/or 4C, and/or devices 500 and 500-a of FIGS. 5A and/or 5B. The base station 105-d may include aspects of a controller 120-a and/or a core network 130-a in some cases. The base station 105-d may include antennas 645, a transceiver module 650, memory 670, and a processor module 665, which each may be in communication, directly or indirectly, with each other (e.g., over one or more buses). The transceiver module 650 may be configured to communicate bi-directionally, via the antennas 645, with the user equipment 115-d, which may be a multi-mode user equipment. The transceiver module 650 (and/or other components of the base station 105-d) may also be configured to communicate bi-directionally with one or more networks. In some cases, the base station 105-d may communicate with the network 130-a through network communications module 675. Base station 105-d may be an example of an eNodeB base station, a Home eNodeB base station, a NodeB base station, a Radio Network Controller (RNC), and/or a Home NodeB base station.

Base station 105-d may also communicate with other base stations 105, such as base station 105-e and base station 105-f Each of the base stations 105 may communicate with user equipment 115-d using different wireless communications technologies, such as different Radio Access Technologies. In some cases, base station 105-d may communicate with other base stations such as 105-e and/or 105-f utilizing base station communication module 631. In some embodiments, base station communication module 631 may provide an X2 interface within an LTE wireless communication technology to provide communication between some of the base stations 105. In some embodiments, base station 105-d may communicate with other base stations through controller 120-a and/or network 130-a.

The memory 670 may include random access memory (RAM) and read-only memory (ROM). The memory 670 may also store computer-readable, computer-executable software code 671 containing instructions that are configured to, when executed, cause the processor module 665 to perform various functions described herein (e.g., call processing, database management, message routing, etc.). Alternatively, the software 671 may not be directly executable by the processor module 665 but be configured to cause the computer, e.g., when compiled and executed, to perform functions described herein.

The processor module 665 may include an intelligent hardware device, e.g., a central processing unit (CPU) such as those made by Intel® Corporation or AMD®, a microcontroller, an application-specific integrated circuit (ASIC), etc. The processor module 665 may include a speech encoder (not shown) configured to receive audio via a microphone, convert the audio into packets (e.g., 20 ms in length) representative of the received audio, provide the audio packets, and/or provide indications of whether a user is speaking.

The transceiver module 650 may include a modem configured to modulate the packets and provide the modulated packets to the antennas 645 for transmission, and to demodulate packets received from the antennas 645. While some examples of the base station 105-d may include a single antenna 645, the base station 105-d preferably includes multiple antennas 645 for multiple links which may support carrier aggregation. For example, one or more links may be used to support macro communications with user equipment 115-d.

According to the architecture of FIG. 6, the base station 105-d may further include a communications management module 630. By way of example, the communications management module 630 may be a component of the base station 105-d in communication with some or all of the other components of the base station 105-d via a bus. Alternatively, functionality of the communications management module 630 may be implemented as a component of the transceiver module 650, as a computer program product, and/or as one or more controller elements of the processor module 665.

The components for base station 105-d may be configured to implement aspects discussed above with respect to device 500 of FIG. 5A and/or device 500-a of FIG. 5B and/or configurations of systems 400-a, 400-b, and/or 400-c of FIGS. 4A, 4B, and/or 4C and may not be repeated here for the sake of brevity. The control information processing time determination module 511-a may be an example of the control information processing time determination module 511 of FIG. 5B. The control information utilization module 512-a may be an example of the control information processing time determination module 512 of FIG. 5B. Furthermore, control information module 510-b, which may include the control information processing time determination module 511-a and the control information utilization module 512-a, may be an example of the control information module 510 of FIG. 5A and/or the control information module 510-a of FIG. 5B.

The base station 105-d may also include a spectrum identification module (not shown). The spectrum identification module may be utilized to identify spectrum available for flexible bandwidth waveforms. In some embodiments, a handover module 625 may be utilized to perform handover procedures of the user equipment 115-d from one base station 105 to another. For example, the handover module 625 may perform a handover procedure of the user equipment 115-d from base station 105-d to another where normal waveforms are utilized between the user equipment 115-d and one of the base stations and flexible bandwidth waveforms are utilized between the user equipment and another base station. A bandwidth scaling module 627 may be utilized to scale and/or alter chip rates and/or time to generate flexible bandwidth waveforms.

In some embodiments, the transceiver module 650 in conjunction with antennas 645, along with other possible components of base station 105-d, may transmit and/or receive information regarding flexible bandwidth waveforms and/or scaling factors from the base station 105-d to the user equipment 115-d, to other base stations 105-e/105-f, or core network 130-a. In some embodiments, the transceiver module 650 in conjunction with antennas 645, along with other possible components of base station 105-d, may transmit and/or receive information to or from the user equipment 115-d, to or from other base stations 105-e/105-f, or core network 130-a, such as flexible bandwidth waveforms and/or scaling factors, such that these devices or systems may utilize flexible bandwidth waveforms.

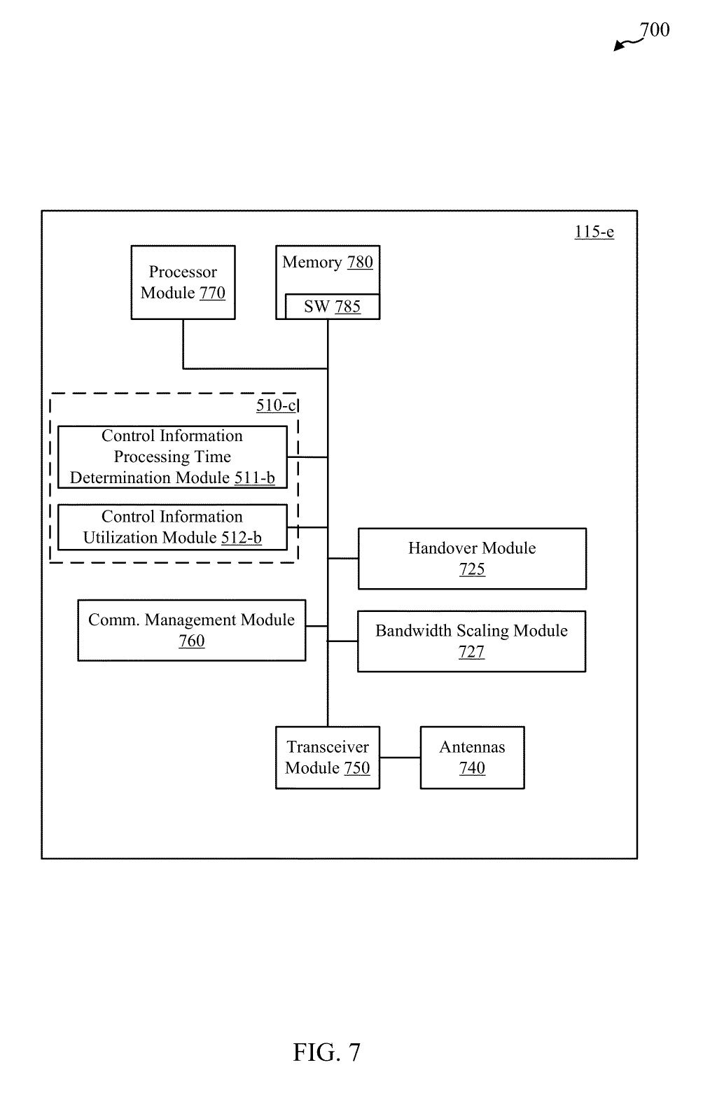

FIG. 7 is a block diagram 700 of a user equipment 115-e configured in accordance with various embodiments. The user equipment 115-e may have any of various configurations, such as personal computers (e.g., laptop computers, netbook computers, tablet computers, etc.), cellular telephones, PDAs, digital video recorders (DVRs), internet appliances, gaming consoles, e-readers, etc. The user equipment 115-e may have an internal power supply (not shown), such as a small battery, to facilitate mobile operation. In some embodiments, the user equipment 115-e may implement aspects of the system 100 depicted in FIG. 1, systems 200-a and 200-b of FIGS. 2A and 2B, system 300 of FIG. 3, systems 400-a, 400-b, and/or 400-c of FIGS. 4A, 4B, and/or 4C, and/or system 600 of FIG. 6; and/or devices 500 and 500-a of FIGS. 5A and/or 5B. The user equipment 115-e may be a multi-mode user equipment. The user equipment 115-e may further be referred to as a wireless communications device in some cases.

The user equipment 115-e may include antennas 740, a transceiver module 750, memory 780, and a processor module 770, which each may be in communication, directly or indirectly, with each other (e.g., via one or more buses). The transceiver module 750 is configured to communicate bi-directionally, via the antennas 740 and/or one or more wired or wireless links, with one or more networks, as described above. For example, the transceiver module 750 may be configured to communicate bi-directionally with base stations 105 of FIG. 1, FIGS. 2A and 2B, FIG. 3, and/or FIG. 6, and/or with devices 500 and 500-a of FIGS. 5A and 5B. The transceiver module 750 may include a modem configured to modulate the packets and provide the modulated packets to the antennas 740 for transmission, and to demodulate packets received from the antennas 740. While the user equipment 115-e may include a single antenna, the user equipment 115-e will typically include multiple antennas 740 for multiple links.

The memory 780 may include random access memory (RAM) and read-only memory (ROM). The memory 780 may store computer-readable, computer-executable software code 785 containing instructions that are configured to, when executed, cause the processor module 770 to perform various functions described herein (e.g., call processing, database management, message routing, etc.). Alternatively, the software 785 may not be directly executable by the processor module 770 but may be configured to cause the computer (e.g., when compiled and executed) to perform functions described herein.

The processor module 770 may include an intelligent hardware device, e.g., a central processing unit (CPU) such as those made by Intel® Corporation or AMD®, a microcontroller, an application-specific integrated circuit (ASIC), etc. The processor module 770 may include a speech encoder (not shown) configured to receive audio via a microphone, convert the audio into packets (e.g., 20 ms in length) representative of the received audio, provide the audio packets to the transceiver module 750, and provide indications of whether a user is speaking. Alternatively, an encoder may only provide packets to the transceiver module 750, with the provision or withholding/suppression of the packet itself providing the indication of whether a user is speaking. The processor module 770 may also include a speech decoder that may perform a reverse functionality as the speech encoder.

According to the architecture of FIG. 7, the user equipment 115-e may further include a communications management module 760. The communications management module 760 may manage communications with other user equipments 115. By way of example, the communications management module 760 may be a component of the user equipment 115-e in communication with some or all of the other components of the user equipment 115-e via a bus. Alternatively, functionality of the communications management module 760 may be implemented as a component of the transceiver module 750, as a computer program product, and/or as one or more controller elements of the processor module 770.

The components for user equipment 115-e may be configured to implement aspects discussed above with respect to device 500 of FIG. 5A and/or device 500-a of FIG. 5B, system 600 of FIG. 6, and/or configurations of systems 400-a, 400-b, and/or 400-c of FIGS. 4A, 4B, and/or 4C, and may not be repeated here for the sake of brevity. The control information processing time determination module 511-b may be an example of the control information processing time determination module 511 of FIG. 5B. The control information utilization module 512-b may be an example of the control information utilization module 512 of FIG. 5B. Furthermore, control information module 510-c, which may include control information processing time determination module 511-b and the control information utilization module 512-b, may be an example of the control information module 510 of FIG. 5A and/or the control information module 510-a of FIG. 5B.

The user equipment 115-e may also include a spectrum identification module (not shown). The spectrum identification module may be utilized to identify spectrum available for flexible bandwidth waveforms. In some embodiments, a handover module 725 may be utilized to perform handover procedures of the user equipment 115-e from one base station to another. For example, the handover module 725 may perform a handover procedure of the user equipment 115-e from one base station to another where normal waveforms are utilized between the user equipment 115-e and one of the base stations and flexible bandwidth waveforms are utilized between the user equipment and another base station. A bandwidth scaling module 727 may be utilized to scale and/or alter chip rates and/or time to generate/decode flexible bandwidth waveforms.

In some embodiments, the transceiver module 750, in conjunction with antennas 740, along with other possible components of user equipment 115-e, may transmit information regarding flexible bandwidth waveforms and/or scaling factors from the user equipment 115-e to base stations or a core network. In some embodiments, the transceiver module 750, in conjunction with antennas 740, along with other possible components of user equipment 115-e, may transmit/receive information, such flexible bandwidth waveforms and/or scaling factors, to/from base stations or a core network such that these devices or systems may utilize flexible bandwidth waveforms.

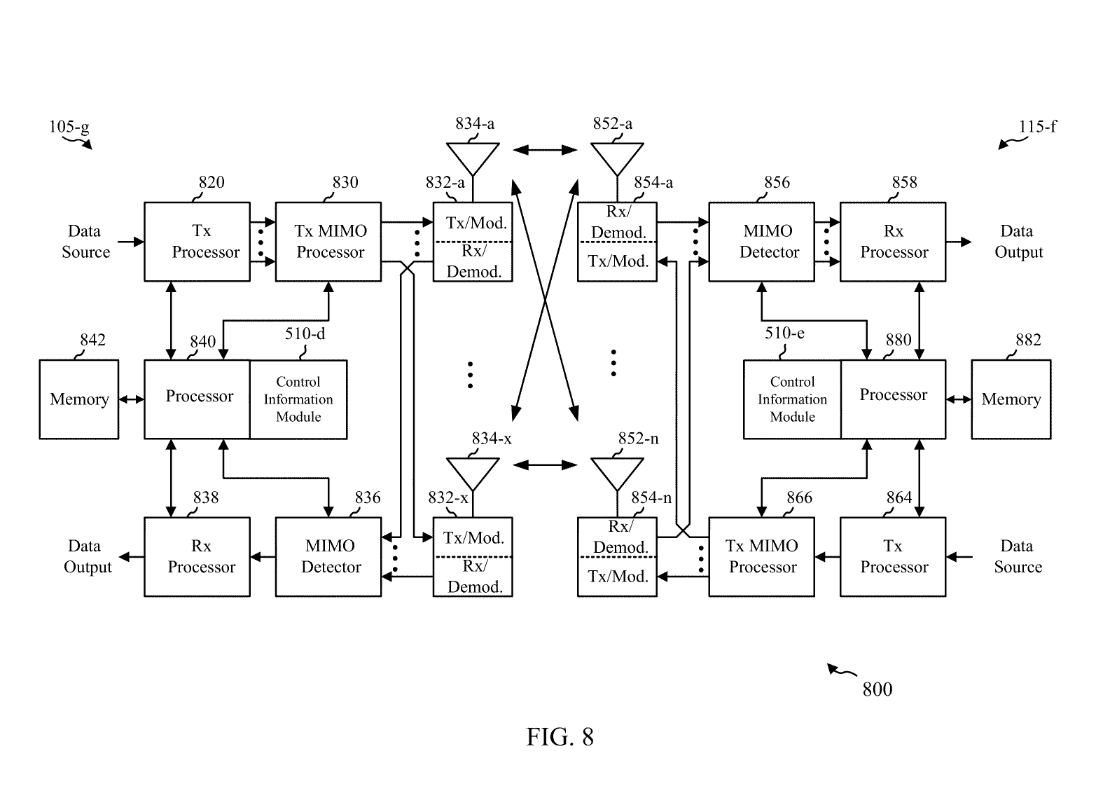

FIG. 8 is a block diagram of a system 800 including a base station 105-g and a user equipment 115-f in accordance with various embodiments. The system 800 may be an example of the system 100 of FIG. 1, systems 200-a and 200-b of FIGS. 2A and 2B, system 300 of FIG. 3, system 600 of FIG. 6, system 700 of FIG. 7, and/or devices 500 and 500-a of FIGS. 5A and 5B. The base station 105-g may be equipped with antennas 834-a through 834-x, and the user equipment 115-f may be equipped with antennas 852-a through 852-n. At the base station 105-g, a transmit processor 820 may receive data from a data source. System 800 may be configured to implement different aspects of the systems as shown in FIGS. 4A, 4B, and/or 4C, and/or the associated descriptions.

The transmit processor 820 may process the data. The transmit processor 820 may also generate reference symbols, and a cell-specific reference signal. A transmit (TX) MIMO processor 830 may perform spatial processing (e.g., precoding) on data symbols, control symbols, and/or reference symbols, if applicable, and may provide output symbol streams to the transmit modulators 832-a through 832-x. Each modulator 832 may process a respective output symbol stream (e.g., for OFDM, etc.) to obtain an output sample stream. Each modulator 832 may further process (e.g., convert to analog, amplify, filter, and upconvert) the output sample stream to obtain a downlink (DL) signal. In one example, DL signals from modulators 832-a through 832-x may be transmitted via the antennas 834-a through 834-x, respectively. The transmit processor 820 may receive information from a processor 840. The processor 840 may be coupled with a memory 842. The processor 840 may be configured to generate flexible bandwidth waveforms through altering a chip rate and/or utilizing a scaling factor. In some embodiments, the processor module 840 may be configured for dynamically adapting flexible bandwidth in accordance with various embodiments. The processor 840 may dynamically adjust one or more scale factors of the flexible bandwidth signal associated with transmissions between base station 105-g and user equipment 115-f. These adjustments may be made based on information such as traffic patterns, interference measurements, etc.

For example, within system 800, the processor 840 may further include a control information module 510-d configured to, upon receiving control information over a first channel of one of the one or more flexible bandwidth carriers, for example via the antennas 834-a through 834-x, determine a processing time for the received control information over the first channel of the one of the one or more flexible bandwidth carriers based on a processing time of control information for a normal bandwidth carrier or another flexible bandwidth carrier. The control information module 510-d may further be configured to utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers. At least the first carrier or the second carrier may include at least one of the one or more flexible bandwidth carriers. The control information module 510-d may be an example of or may incorporate aspects of the control information module 510, 510-a, 510-b, and 510-c of FIGS. 5A, 5B, 6, and/or 7.

At the user equipment 115-f, the user equipment antennas 852-a through 852-n may receive the DL signals from the base station 105-g and may provide the received signals to the demodulators 854-a through 854-n, respectively. Each demodulator 854 may condition (e.g., filter, amplify, downconvert, and digitize) a respective received signal to obtain input samples. Each demodulator 854 may further process the input samples (e.g., for OFDM, etc.) to obtain received symbols. A MIMO detector 856 may obtain received symbols from all the demodulators 854-a through 854-n, perform MIMO detection on the received symbols, if applicable, and provide detected symbols. A receive processor 858 may process (e.g., demodulate, deinterleave, and decode) the detected symbols, providing decoded data for the user equipment 115-f to a data output, and provide decoded control information to a processor 880, or memory 882.

On the uplink (UL) or reverse link, at the user equipment 115-f, a transmit processor 864 may receive and process data from a data source. The transmitter processor 864 may also generate reference symbols for a reference signal. The symbols from the transmit processor 864 may be precoded by a transmit MIMO processor 866, if applicable, further processed by the demodulators 854-a through 854-n (e.g., for SC-FDMA, etc.), and be transmitted to the base station 105-g in accordance with the transmission parameters received from the base station 105-g. The transmit processor 864 may also be configured to generate flexible bandwidth waveforms through altering a chip rate and/or utilizing a scaling factor; this may be done dynamically in some cases. The transmit processor 864 may receive information from processor 880. The processor 880 may provide for different alignment and/or offsetting procedures. The processor 880 may also utilize scaling and/or chip rate information to perform measurements on the other subsystems, perform handoffs to the other subsystems, perform reselection, etc. The processor 880 may invert the effects of time stretching associated with the use of flexible bandwidth through parameter scaling. At the base station 105-g, the UL signals from the user equipment 115-f may be received by the antennas 834, processed by the demodulators 832, detected by a MIMO detector 836, if applicable, and further processed by a receive processor 838. The receive processor 838 may provide decoded data to a data output and to the processor 840. In some embodiments, the processor 840 may be implemented as part of a general processor, the transmit processor 830, and/or the receiver processor 838.

In some embodiments, the processor module 880 may be configured for dynamically adapting flexible bandwidth in accordance with various embodiments. The processor 880 may dynamically adjust one or more scale factors of the flexible bandwidth signal associated with transmissions between base station 105-g and user equipment 115-f. These adjustments may be made based on information such as traffic patterns, interference measurements, etc.

For example, within system 800, the processor 880 may further include a control information module 510-e configured to, upon receiving control information over a first channel of one of the one or more flexible bandwidth carriers, for example via the antennas 852-a through 852-n, determine a processing time for the received control information over the first channel of the one of the one or more flexible bandwidth carriers based on a processing time of control information for a normal bandwidth carrier or another flexible bandwidth carrier. The control information module 510-e may further be configured to utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers. At least the first carrier or the second carrier may include at least one of the one or more flexible bandwidth carriers. The control information module 510-e may be an example of or may incorporate aspects of the control information module 510, 510-a, 510-b, and 510-c of FIGS. 5A, 5B, 6, and/or 7. Furthermore, the control information module 510-e may coordinate and/or share functionality with the control information module 510-d.

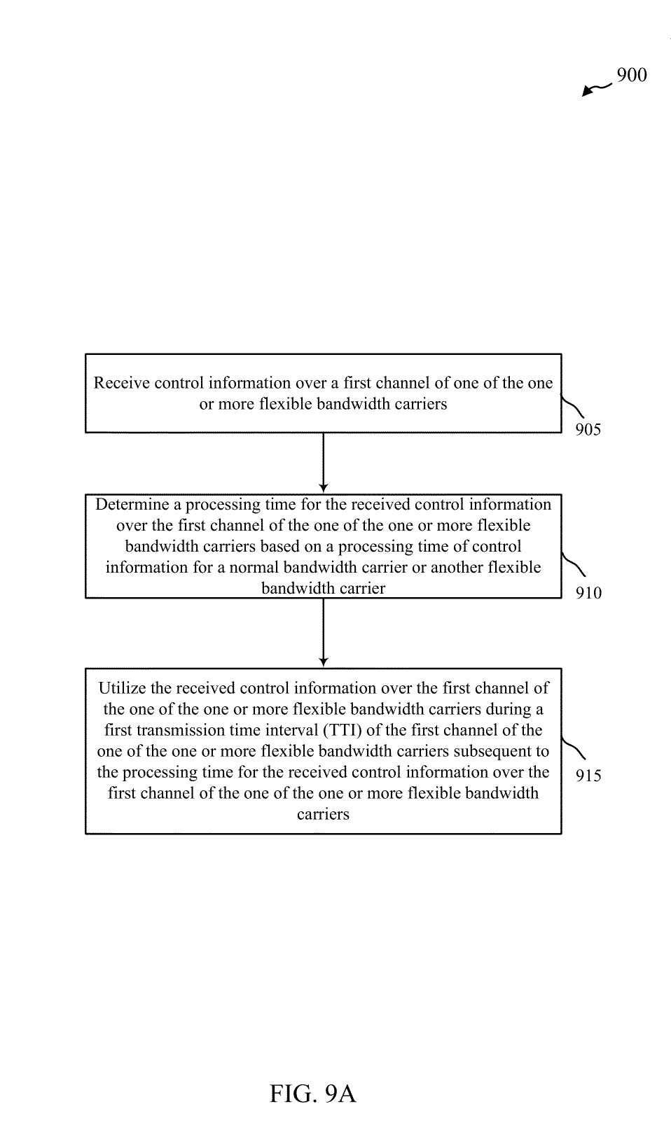

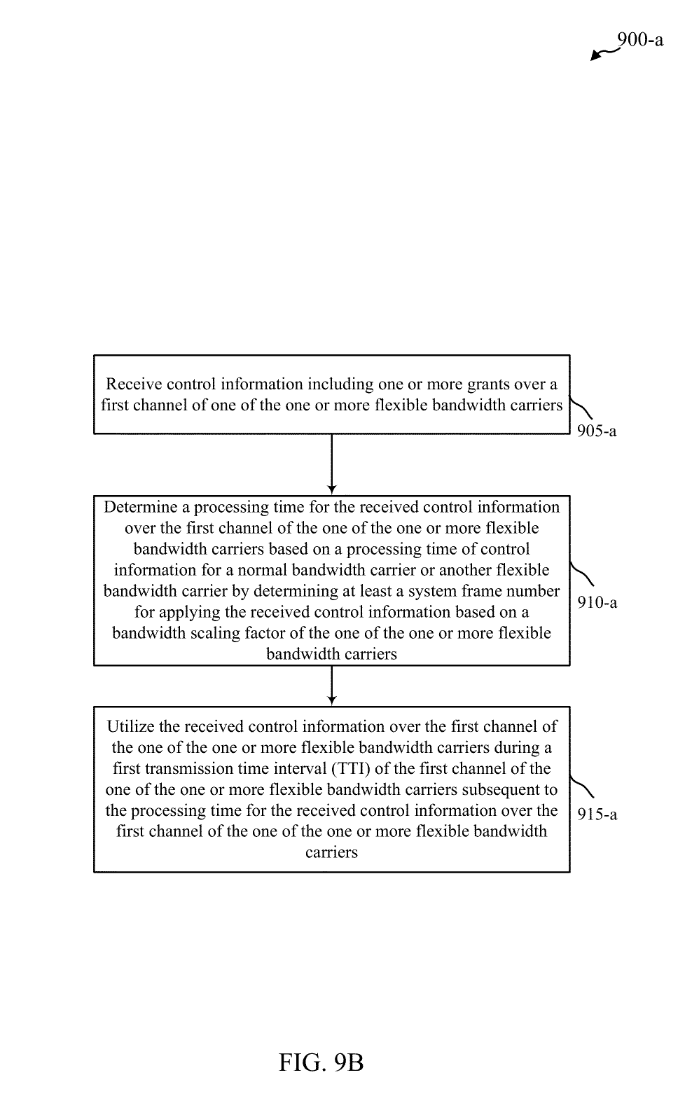

Turning to FIG. 9A, a flow diagram of a method 900 for control information processing and utilization in a multicarrier system that utilizes one or more flexible bandwidth carriers is provided in accordance with various embodiments. Method 900 may be implemented utilizing various wireless communications devices and/or systems including, but not limited to: system 100 of FIG. 1, systems 200-a and 200-b of FIGS. 2A and 2B, system 300 of FIG. 3, systems 400-a, 400-b, and/or 400-c of FIGS. 4A, 4B, and/or 4C, system 600 of FIG. 6, system 700 of FIG. 7, and/or system 800 of FIG. 8; the base stations 105 of FIG. 1, FIG. 2A, FIG. 2B, FIG. 3, FIG. 6, and/or FIG. 8; the user equipment 115 of FIG. 1, FIG. 2A, FIG. 2B, FIG. 3, FIG. 6, FIG. 7, and/or FIG. 8; the controller 120/core network 130 of FIGS. 1 and/or 6; and/or devices 500 and 500-a of FIGS. 5A and 5B.

At block 905, control information may be received over a first channel of one of the one or more flexible bandwidth carriers, such as at a UE 115.

At block 910, a processing time for the received control information over the first channel of the one of the one or more flexible bandwidth carriers may be determined based on a processing time of control information for a normal bandwidth carrier or another flexible bandwidth carrier.

At block 915, the received control information over the first channel of the one of the one or more flexible bandwidth carriers may be utilized during a first transmission time interval (TTI) of the first channel of the one of the one or more flexible bandwidth carriers subsequent to the processing time for the received control information over the first channel of the one of the one or more flexible bandwidth carriers.

In some embodiments, the method 900 may also include receiving the control information for the normal bandwidth carrier or the other flexible bandwidth carrier over a channel of the normal bandwidth carrier or the other flexible bandwidth carrier, and utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

In further embodiments, the method 900 may include receiving control information over a second channel of one of the one or more flexible bandwidth carriers. Method 900 may further include determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers. In some cases, method 900 may further include utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

In some embodiments, determining the processing time for the received control information over the first channel of the one of the one or more flexible bandwidth carriers may include determining at least a system frame number for applying the received control information based on a bandwidth scaling factor of the first channel of one of the one or more flexible bandwidth carriers.

In some cases, the processing time for the received control information over the first channel of the one of the one or more flexible bandwidth carriers may equal the processing time of the control information for the normal bandwidth carrier or the other flexible bandwidth carrier. In some embodiments, the processing time for the received control information over the first channel of the one of the one or more flexible bandwidth carriers may be less than a dilated processing time, which may be less than a theoretical processing time, for the received control information over the first channel of the one of the one or more flexible bandwidth carriers.

In some cases, the processing time for the received control information over the first channel of the one of the one or more flexible bandwidth carriers may be undilated with respect to the processing time for a normal bandwidth carrier or another flexible bandwidth carrier. In other words, this may equate to the processing time for the received control information over the first channel of the one of the one or more flexible bandwidth carriers, when adjusted, being undilated in relation to other signaling of the flexible bandwidth carrier.

In some embodiments, the control information over the first channel of one of the one or more flexible bandwidth carriers may include one or more grants. In some cases, the first channel of the one of the one or more flexible bandwidth carriers may include one of an Enhanced Absolute Grant Channel (E-AGCH) or Enhanced Relative Grant Channel (E-RGCH). The one of the one or more flexible bandwidth carriers may utilize a bandwidth scaling factor equal to 2 or 4.

Turning to FIG. 9B, a flow diagram of a method 900-a for control information processing and utilization in a multicarrier system that utilizes one or more flexible bandwidth carriers is provided in accordance with various embodiments. Method 900-a may be implemented utilizing various wireless communications devices and/or systems including, but not limited to: system 100 of FIG. 1, systems 200-a and 200-b of FIGS. 2A and 2B, system 300 of FIG. 3, systems 400-a, 400-b, and/or 400-c, of FIGS. 4A, 4B, and/or 4C, system 600 of FIG. 6, system 700 of FIG. 7, and/or system 800 of FIG. 8; the base stations 105 of FIG. 1, FIG. 2A, FIG. 2B, FIG. 3, FIG. 6, and/or FIG. 8; the user equipment 115 of FIG. 1, FIG. 2A, FIG. 2B, FIG. 3, FIG. 6, FIG. 7, and/or FIG. 8; the controller 120/core network 130 of FIGS. 1 and/or 6; and/or devices 500 and 500-a of FIGS. 5A and 5B. Method 900-a may be an example of method 900 of FIG. 9A.

At block 905-a, control information including one or more grants may be received over a first channel of one of the one or more flexible bandwidth carriers, such as at a UE 115.

At block 910-a, a processing time for the received control information over the first channel of the one of the one or more flexible bandwidth carriers may be determined based on a processing time of control information for a normal bandwidth carrier or another flexible bandwidth carrier by determining at least a system frame number for applying the received control information based on a bandwidth scaling factor of the one of the one or more flexible bandwidth carriers.

At block 915-a, the received control information over the first channel of the one of the one or more flexible bandwidth carriers may be utilized during a first transmission time interval (TTI) of the first channel of the one of the one or more flexible bandwidth carriers subsequent to the processing time for the received control information over the first channel of the one of the one or more flexible bandwidth carriers. At least one of the carriers may include a flexible bandwidth carrier.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of control information processing and utilization for a wireless communications system that utilizes one or more flexible bandwidth carriers, the method comprising:
receiving control information over a first channel of one of the one or more flexible bandwidth carriers;
determining a processing time for the received control information over the first channel of the one of the one or more flexible bandwidth carriers based on a processing time of control information for a normal bandwidth carrier or another flexible bandwidth carrier; and
utilizing the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

2. The method of claim 1, further comprising:
receiving the control information for the normal bandwidth carrier or the other flexible bandwidth carrier over a channel of the normal bandwidth carrier or the other flexible bandwidth carrier; and
utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

3. The method of claim 1, further comprising:
receiving control information over a second channel of one of the one or more flexible bandwidth carriers;
determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and
utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

4. The method of claim 1, wherein determining the processing time for the received control information over the first channel of the one of the one or more flexible bandwidth carriers comprises determining at least a system frame number for applying the received control information based on a bandwidth scaling factor of the first channel of one of the one or more flexible bandwidth carriers.

5. The method of claim 1, wherein the processing time for the received control information over the first channel of the one of the one or more flexible bandwidth carriers equals the processing time of the control information for the normal bandwidth carrier or the other flexible bandwidth carrier.

6. The method of claim 1, wherein the processing time for the received control information over the first channel of the one of the one or more flexible bandwidth carriers is less than a dilated processing time for the received control information over the first channel of the one of the one or more flexible bandwidth carriers.

7. The method of claim 1, wherein the control information over the first channel of one of the one or more flexible bandwidth carriers comprises one or more grants.

8. The method of claim 1, wherein the first channel of the one of the one or more flexible bandwidth carriers comprises at least an Enhanced Absolute Grant Channel (E-AGCH) or an Enhanced Relative Grant Channel (E-RGCH).

9. The method of claim 1, wherein the one of the one or more flexible bandwidth carriers of the first channel comprises a bandwidth scaling factor equal to 2 or 4.

10. A system for control information processing and utilization in a wireless communications system that utilizes one or more flexible bandwidth carriers, the system comprising:
means for receiving control information over a first channel of one of the one or more flexible bandwidth carriers;
means for determining a processing time for the received control information over the first channel of the one of the one or more flexible bandwidth carriers based on a processing time of control information for a normal bandwidth carrier or another flexible bandwidth carrier; and
means for utilizing the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

11. The system of claim 10, further comprising:
means for receiving the control information for the normal bandwidth carrier or the other flexible bandwidth carrier over a channel of the normal bandwidth carrier or the other flexible bandwidth carrier; and
means for utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

12. The system of claim 10, further comprising:
means for receiving control information over a second channel of one of the one or more flexible bandwidth carriers;
means for determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and
means for utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

13. The system of claim 10, wherein the means for determining the processing time for the received control information over the first channel of the one of the one or more flexible bandwidth carriers comprises means for determining at least a system frame number for applying the received control information based on a bandwidth scaling factor of the first channel of one of the one or more flexible bandwidth carriers.

14. The system of claim 10, wherein the processing time for the received control information over the first channel of the one of the one or more flexible bandwidth carriers equals the processing time of the control information for the normal bandwidth carrier or the other flexible bandwidth carrier.

15. The system of claim 10, wherein the processing time for the received control information over the first channel of the one of the one or more flexible bandwidth carriers is less than a dilated processing time for the received control information over the first channel of the one of the one or more flexible bandwidth carriers.

16. The system of claim 10, wherein the control information over the first channel of one of the one or more flexible bandwidth carriers comprises one or more grants.

17. The system of claim 10, wherein the first channel of the one of the one or more flexible bandwidth carriers comprises at least an Enhanced Absolute Grant Channel (E-AGCH) or an Enhanced Relative Grant Channel (E-RGCH).

18. The system of claim 10, wherein the one of the one or more flexible bandwidth carriers of the first channel comprises a bandwidth scaling factor equal to 2 or 4.

19. A computer program product for control information processing and utilization in a wireless communications system that utilizes one or more flexible bandwidth carriers comprising:
a non-transitory computer-readable medium comprising:
code for receiving control information over a first channel of one of the one or more flexible bandwidth carriers;
code for determining a processing time for the received control information over the first channel of the one of the one or more flexible bandwidth carriers based on a processing time of control information for a normal bandwidth carrier or another flexible bandwidth carrier; and
code for utilizing the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

20. The computer program product of claim 19, wherein the non-transitory computer-readable medium further comprises:
code for receiving the control information for the normal bandwidth carrier or the other flexible bandwidth carrier over a channel of the normal bandwidth carrier or the other flexible bandwidth carrier; and
code for utilizing the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

21. The computer program product of claim 19, wherein the non-transitory computer-readable medium further comprises:
code for receiving control information over a second channel of one of the one or more flexible bandwidth carriers;
code for determining a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and
code for utilizing the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

22. The computer program product of claim 19, wherein the code for determining the processing time for the received control information over the first channel of the one of the one or more flexible bandwidth carriers comprises code for determining at least a system frame number for applying the received control information based on a bandwidth scaling factor of the first channel of one of the one or more flexible bandwidth carriers.

23. The computer program product of claim 19, wherein the processing time for the received control information over the first channel of the one of the one or more flexible bandwidth carriers equals the processing time of the control information for the normal bandwidth carrier or the other flexible bandwidth carrier.

24. computer program product of claim 19, wherein the processing time for the received control information over the first channel of the one of the one or more flexible bandwidth carriers is less than a dilated processing time for the received control information over the first channel of the one of the one or more flexible bandwidth carriers.

25. The computer program product of claim 19, wherein the control information over the first channel of one of the one or more flexible bandwidth carriers comprises one or more grants.

26. The computer program product of claim 19, wherein the first channel of the one of the one or more flexible bandwidth carriers comprises at least an Enhanced Absolute Grant Channel (E-AGCH) or an Enhanced Relative Grant Channel (E-RGCH).

27. The computer program product of claim 19, wherein the one of the one or more flexible bandwidth carriers of the first channel comprises a bandwidth scaling factor equal to 2 or 4.

28. A wireless communications device configured for control information processing and utilization in a wireless communications system that utilizes one or more flexible bandwidth carriers comprising:
at least one processor configured to:
receive control information over a first channel of one of the one or more flexible bandwidth carriers;
determine a processing time for the received control information over the first channel of the one of the one or more flexible bandwidth carriers based on a processing time of control information for a normal bandwidth carrier or another flexible bandwidth carrier; and
utilize the received control information over the first channel of the one of the one or more flexible bandwidth carriers during a first transmission time interval (TTI) of the first channel of the one of the one or more flexible bandwidth carriers subsequent to the processing time for the received control information over the first channel of the one of the one or more flexible bandwidth carriers.

29. The wireless communications device of claim 28, wherein the at least one processor is further configured to:
receive the control information for the normal bandwidth carrier or the other flexible bandwidth carrier over a channel of the normal bandwidth carrier or the other flexible bandwidth carrier; and
utilize the received control information for the normal bandwidth carrier or the other flexible bandwidth carrier during a first transmission time interval (TTI) of the channel of the normal bandwidth carrier or the other flexible bandwidth carrier subsequent to the processing time for the received control information over the channel of the normal bandwidth carrier or the other flexible bandwidth carrier.

30. The wireless communications device of claim 28, wherein the at least one processor is further configured to:
receive control information over a second channel of one of the one or more flexible bandwidth carriers;
determine a processing time for the received control information over the second channel of the one of the one or more flexible bandwidth carriers based on a processing time of the control information for the normal bandwidth carrier or the other flexible bandwidth carrier and the determined processing time for the received control information over the channel of the one or more flexible bandwidth carriers; and
utilize the received control information over the second channel of the one of the one or more flexible bandwidth carriers during a first transmission time interval (TTI) of the second channel of the one of the one or more flexible bandwidth carriers subsequent to the processing time for the received control information over the second channel of the one of the one or more flexible bandwidth carriers.

31. The wireless communications device of claim 28, wherein the at least one processor configured to determine the processing time for the received control information over the first channel of the one of the one or more flexible bandwidth carriers is further configured to determine at least a system frame number for applying the received control information based on a bandwidth scaling factor of the first channel of one of the one or more flexible bandwidth carriers.

32. The wireless communications device of claim 28, wherein the processing time for the received control information over the first channel of the one of the one or more flexible bandwidth carriers equals the processing time of the control information for the normal bandwidth carrier or the other flexible bandwidth carrier.

33. The wireless communications device of claim 28, wherein the processing time for the received control information over the first channel of the one of the one or more flexible bandwidth carriers is less than a dilated processing time for the received control information over the first channel of the one of the one or more flexible bandwidth carriers.

34. The wireless communications device of claim 28, wherein the control information over the first channel of one of the one or more flexible bandwidth carriers comprises one or more grants.

35. The wireless communications device of claim 28, wherein the first channel of the one of the one or more flexible bandwidth carriers comprises at least an Enhanced Absolute Grant Channel (E-AGCH) or an Enhanced Relative Grant Channel (E-RGCH).

36. The wireless communications device of claim 28, wherein the one of the one or more flexible bandwidth carriers of the first channel comprises a bandwidth scaling factor equal to 2 or 4.
